(19) United States
(12) Patent Application Publication
(10) Pub. No.: US 2024/0161142 A1
(43) Pub. Date: May 16, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventor: TAKUMA UDAGAWA, TOKYO (JP)

(21) Appl. No.: 18/549,197

(22) PCT Filed: Jan. 17, 2022
(86) PCT No.: PCT/JP2022/001328

§ 371 Date: Sep. 6, 2023

(30) Foreign Application Priority Data
Mar. 15, 2021 (JP) 2021-041074

(51) Int. Cl. G06Q 30/0211; G06Q 10/0639

(52) U.S. Cl. CPC G06Q 30/0211; G06Q 10/06393

(57) ABSTRACT

The present technology relates to an information processing apparatus, an information processing method, and a program that are enabled to construct a system suitable for validation of effects of causal inference.

An intervention processing systems generates an intervention allocation description including comparison information between a first intervention allocation indicating a correspondence relation between a user feature amount and an intervention and a second intervention allocation indicating a correspondence relation between the user feature amount and the intervention and newly provided using a learning model, and comparison information for an expected evaluated value between a case where the intervention is performed on a basis of the first intervention allocation and a case where the intervention is performed on a basis of the second intervention allocation. The present technology can be applied to an intervention processing system providing coupons to users at EC sites.

### TECHNICAL FIELD

The present technology relates to an information processing apparatus, an information processing method, and a program, and in particular, to an information processing apparatus, an information processing method, and a program that are enabled to construct a system suitable for validation of effects of causal inference.

### BACKGROUND ART

Marketers have planned measures for, for example, coupon provision and the like at EC (Electronic Commerce) sites. However, a recently developed data utilization technology has allowed per-user optimum measures to be estimated using a machine learning model (see PTL 1), and there have been examples in which such estimation is applied to actual systems.

The above-described technology is referred to as “causal inference of effects of intervention (uplift modeling),” and is a technology different from machine learning models for predicting general behavior such as clicking or purchase. For example, available methods include those for estimating effects of an intervention (lift effects), those for directly estimating an optimum intervention without estimating lift effects, and the like.

A system suitable for causal inference (data collection, model training and evaluation, operation, and the like) is required for optimizing the intervention using the technology for causal inference as described above.

### CITATION LIST

### Patent Literature

[PTL 1]

Japanese Patent Laid-open No. 2016-118975

### SUMMARY

### Technical Problem

However, existing systems are not designed to be assumed for validation of effects of causal inference. Consequently, a person in charge needs to manually perform data collection, training and evaluation of a machine learning model, operation, and the like.

That is, to optimize the intervention, a system is desired that enables seamless continuation of data collection, model training and evaluation, and operation that are suitable for validation of effects of causal inference.

In view of such circumstances, an object of the present technology is to allow construction of a system suitable for validation of effects of causal inference.

### Solution to Problem

An information processing apparatus according to an aspect of the present technology includes a description generating section generating an intervention allocation description including comparison information between a first intervention allocation indicating a correspondence relation between a user feature amount and an intervention and a second intervention allocation indicating a correspondence relation between the user feature amount and the intervention and newly provided using a learning model, and comparison information for an expected evaluated value between a case where the intervention is performed on the basis of the first intervention allocation and a case where the intervention is performed on the basis of the new intervention allocation.

An aspect of the present technology generates an intervention allocation description including comparison information between a first intervention allocation indicating a correspondence relation between a user feature amount and an intervention and a second intervention allocation indicating a correspondence relation between the user feature amount and the intervention and newly provided using a learning model, and comparison information for an expected evaluated value between a case where the intervention is performed on the basis of the first intervention allocation and a case where the intervention is performed on the basis of the new intervention allocation.

### BRIEF DESCRIPTION OF DRAWINGS

FIG. 1 is a block diagram depicting a functional configuration of a first embodiment of an intervention processing system to which the present technology is applied.

FIG. 2 is a flowchart for describing processing of the intervention processing system.

FIG. 3 is a diagram illustrating an example in which a baseline intervention allocation and a model intervention allocation are directly applied to users in a target segment.

FIG. 4 is a diagram illustrating an example in which a random intervention is added to the baseline intervention allocation and the model intervention allocation.

FIG. 5 is a flowchart for describing estimation processing for an intervention randomization rate in step S16 of FIG. 2.

FIG. 6 is a diagram illustrating an example of a user log and an intervention allocation.

FIG. 7 is a flowchart for describing generation of an intervention allocation description in step S21 of FIG. 2.

FIG. 8 is a diagram illustrating an example of a decision tree.

FIG. 9 is a diagram illustrating an example of a UI related to an intervention allocation description.

FIG. 10 is a flowchart for describing training of an offline evaluation model in step S18 of FIG. 2.

FIG. 11 is a diagram illustrating an example of data regarding actual intervention results fed from an intervention result analyzing section.

FIG. 12 is a diagram illustrating an example of data saved in a model offline evaluation result saving section.

FIG. 13 is a diagram illustrating an example of data including intervention results coupled to offline evaluation results.

FIG. 14 is a diagram illustrating an example of data obtained by evaluation of an offline evaluation method using intervention results.

FIG. 15 is a diagram illustrating an example of data saved in an evaluation result saving section for the offline evaluation method.

FIG. 16 is a diagram illustrating an example of a UI that can adjust the rate of a random intervention.

FIG. 17 is a diagram illustrating an example of a UI presented by an intervention design checking section.

FIG. 18 is a diagram illustrating an example of learning data for an offline evaluation model to which intervention allocation information is added.

FIG. 19 is a diagram illustrating an example of offline evaluation by a model offline evaluation section.

FIG. 20 is a diagram illustrating an example of a generated intervention allocation description.

FIG. 21 is a diagram illustrating an example of a UI presented by the intervention design checking section.

FIG. 22 is a diagram illustrating an example of an UI of FIG. 21 with a rate of random coupon provision adjusted.

FIG. 23 is a diagram illustrating an example of a UI presented by the intervention result checking section.

FIG. 24 is a diagram illustrating an example of data including data saved in a model offline evaluation result saving section and coupled to results of actual coupon provision.

FIG. 25 is a diagram illustrating an example of data obtained by the evaluation of the offline evaluation method using intervention results.

FIG. 26 is a block diagram illustrating a configuration example of a computer.

### DESCRIPTION OF EMBODIMENT

Forms in which the present technology is implemented will be described. Information for which description will be given in the following order shall be presented in the following order.

### 1. Intervention Processing System

### 2. Variations

### 3. Use Cases

### 4. Others

### <1. Intervention Processing System>

### <Configuration Example of Intervention Processing System>

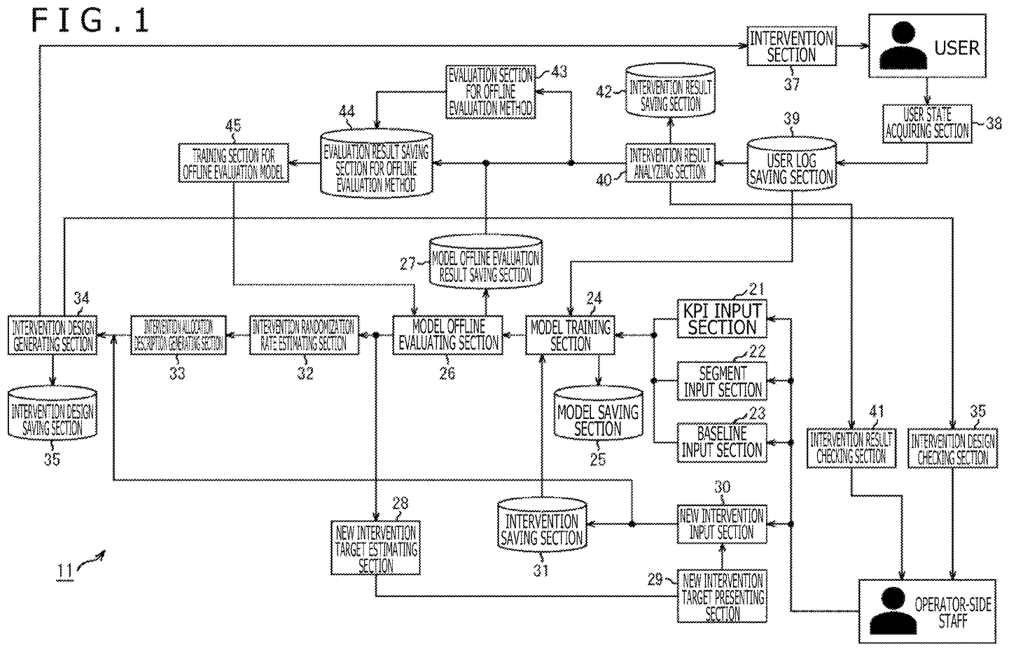

FIG. 1 is a block diagram depicting a functional configuration of an embodiment of an intervention processing system to which the present technology is applied.

An intervention processing system 11 in FIG. 1 intervenes with a user in order to improve a KPI (Key Performance Indicator) that is an evaluated value. Intervention is an action such as information presentation or measures delivery which is taken to encourage the user to behave toward content (viewing, purchase, clicking, or the like). The measures delivery includes, for example, coupon provision at an EC (Electronic Commerce) site. The present technology will be described below using the KPI as an evaluated value. However, any other evaluated value may be used.

The functional configuration depicted in FIG. 1 is implemented by a CPU of a server not illustrated by executing predetermined programs.

The intervention processing system 11 includes a KPI input section 21, a segment input section 22, a baseline input section 23, a model training section 24, a model saving section 25, a model offline evaluating section 26, and a model offline evaluation result saving section 27. The intervention processing system 11 includes a new intervention target estimating section 28, a new intervention target presenting section 29, a new intervention input section 30, an intervention saving section 31, an intervention randomization rate estimating section 32, an intervention allocation description generating section 33, and an intervention design generating section 34.

Additionally, the intervention processing system 11 includes an intervention design saving section 35, an intervention design checking section 36, an intervention section 37, a user state acquiring section 38, a user log saving section 39, and an intervention result analyzing section 40. The intervention processing system 11 includes an intervention result checking section 41, an intervention result saving section 42, an evaluation section 43 for an offline evaluation method, an evaluation result saving section 44 for the offline evaluation method, and a training section 45 for an offline evaluation model.

In response to operation of an operator-side staff member, the KPI input section 21 inputs a KPI to be optimized by intervention and outputs the KPI to the model training section 24. The KPI is, for example, sales, purchasing quantity, the number of page views, or the like. A plurality of KPIs may be input.

In response to operation of an operator-side staff member, the segment input section 22 receives, as an input, a user segment (segment) to be optimized by intervention, and outputs the user segment to the model training section 24. For example, in a case where coupon provision at an EC site and the like is provided by intervention, long-term users who have utilized the EC site for a long time, elderly users, male users, or the like are input as a user segment to be optimized.

In response to the operation of the operator-side staff member, the baseline input section 23 receives a baseline as an input and outputs the baseline to the model training section 24. The baseline refers to an existing intervention allocation to be compared with a new intervention allocation based on model training, and includes, for example, an intervention allocation manually designed by a conventional marketer.

Here, the intervention allocation is information indicating which intervention is allocated to which user feature amount, that is, a correspondence relation between the user feature amount and the intervention.

The model training section 24 trains a model using a user log saved in the user log saving section 39 and intervention information saved in the intervention saving section 31. The model learns a per-user optimum intervention allocation fed from the segment input section 22 in such a manner as to maximize the KPI fed from the KPI input section 21. As a result of learning of the model, the model outputs a new intervention allocation.

The model training section 24 outputs the learned model to the model saving section 25. The model training section 24 outputs, to the model offline evaluating section 26, the learned model and data used to train the model.

The model saving section 25 saves the model fed from the model training section 24.

The model offline evaluating section 26 performs offline evaluation on the model fed by the model training section 24.

The offline evaluation of the model using causal inference, which is performed by the model offline evaluating section 26, differs from machine leaning for general behavior prediction. The offline evaluation of the model using causal inference is referred to as Off-Policy Evaluation (OPE), and includes many methods. OPE methods include, for example, Inverse Probability Weighting (IPW), Direct Method (DM), and Doubly Robust (DR). Performing the OPE leads to calculation of a predicted value for an expected KPI expected in a case where intervention is performed in accordance with a certain intervention allocation (the predicted value is also referred to as a KPI (evaluated) expected value).

The model offline evaluating section 26 uses an offline evaluation model trained by the training section 45 for the offline evaluation model. The offline evaluation model is a “model predicting a true KPI using, as inputs, predicted values for the expected KPIs provided by a plurality of OPEs such as IPW, DM, and DR and the data feature amount.” The true KPI is a measured (evaluated) KPI value obtained when intervention allocation is performed on an evaluation target to be evaluated.

The model offline evaluating section 26 calculates a predicted value for the expected KPI obtained by the offline evaluation model using, as inputs, data used for offline evaluation, information regarding an actual intervention plan, and a predicted value for the expected KPI for the OPE-based intervention allocation (model and baseline). The predicted value for the expected KPI provided by the offline evaluation model corresponds to an offline evaluated value. Using the offline evaluation model allows offline evaluation to be performed using offline evaluated values obtained by a plurality of OPE methods.

Note that the data used for the offline evaluation is often the same as data used for training of the model.

The data used for the offline evaluation, the predicted values for the expected KPIs provided by the OPEs, and the like are output to the model offline evaluation result saving section 27 and the intervention randomization rate estimating section 32. The calculated offline evaluated value is output to the new intervention target estimating section 28.

The model offline evaluation result saving section 27 saves the data used for the offline evaluation, the predicted values for the expected KPIs provided by the OPEs, and the like, which are fed from the model offline evaluating section 26. In the model offline evaluation result saving section 27, the predicted value for the expected KPI provided by each OPE is saved as an offline evaluated value provided by the OPE.

On the basis of the offline evaluated values fed from the model offline evaluating section 26, the new intervention target estimating section 28 estimates whether or not there is any user for whom the existing intervention is not expected to be effective. In a case where the new intervention target estimating section 28 estimates that there is a user for whom the existing intervention is not expected to be effective, the new intervention target estimating section 28 extracts the user feature amount of the user and outputs the extracted user feature amount to the new intervention target presenting section 29.

On the basis of the user feature amount fed from the new intervention target estimating section 28, the new intervention target presenting section 29 presents the feature amount of the user for whom the existing intervention is not expected to be effective, and encourages the operator-side staff member to add a new intervention targeted for the user.

In response to operation of the operator-side staff member, the new intervention input section 30 receives, as an input, information regarding a new intervention, and outputs the received intervention information to the intervention saving section 31 and the intervention design generating section 34.

The intervention saving section 31 saves the intervention information fed from the new intervention input section 30.

The intervention randomization rate estimating section 32 estimates the optimum rate of a random intervention with users. The rate of the random intervention with users refers to the rate at which the intervention is randomly allocated to the users. The intervention randomization rate estimating section 32 outputs the estimated rate of the random intervention with users to the intervention allocation description generating section 33 along with the data used for the offline evaluation fed from the model offline evaluating section 26.

The intervention allocation description generating section 33 generates an intervention allocation description including comparison information (difference information) between the baseline and the model for the predicted values for the intervention and expected KPIs. At that time, in addition to the data used for the offline evaluation fed from the intervention randomization rate estimating section 32, the rate of the random intervention with users is also referenced. The intervention allocation description generating section 33 outputs a generated intervention allocation description to the intervention design generating section 34 along with the data used for the offline evaluation and the rate of the random intervention with the user.

The intervention design generating section 34 generates final intervention design information on the basis of the data used for the offline evaluation, the rate of the random intervention with the user, the intervention allocation description, and the like. Note that the intervention design generating section 34 also references information regarding the new intervention fed from the new intervention input section 30. The intervention design generating section 34 outputs the generated intervention design information to the intervention design saving section 35 and the intervention section 37. The intervention design generating section 34 also outputs the generated intervention design information to the intervention design checking section 36.

The intervention design saving section 35 saves the intervention design information fed from the intervention design generating section 34.

To have the operator-side staff member check before actual intervention, the intervention design checking section 36 presents the intervention design information fed from the intervention design generating section 34.

On the basis of the intervention design information generated by the intervention design generating section 34, the intervention section 37 performs the intervention on the user, that is, a display section of a user terminal.

The user state acquiring section 38 acquires, from a UI (User Interface) of the user terminal or a sensor, information indicating behavior taken by the user as a result of the performed intervention, and outputs the acquired information to the user log saving section 39. Note that, also while the intervention is not performed, the user state acquiring section 38 acquires information indicating the behavior taken by the user.

The behavior taken by the user includes clicking or tapping for the intervention, purchase of an article, browsing of detail pages of the content, actual viewing of the convent, feedback such as the completion or incompletion of viewing, good/bad, or five-grade evaluation, or the like.

In a case where the acquired information is sensor data, the user state acquiring section 38 estimates an action (that is, the behavior taken by the user) from the expression of the user or any other biological information, and outputs, to the user log saving section 39, information indicating the estimated action.

The user log saving section 39 saves, as a user log, the information fed from the user state acquiring section 38. Note that the user log saving section 39 also saves, in association with the user log, information related to the intervention performed in the intervention section 37 (for example, a content ID indicating which content is subjected to the intervention, an intervention ID identifying the intervention, or the like).

The intervention result analyzing section 40 references the user log in the user log saving section 39 to compare the model intervention allocation with the baseline intervention allocation and analyze intervention results by determining whether or not the measured KPI value has improved, and the like.

The intervention result analyzing section 40 outputs the comparison result of the comparison between the model intervention allocation and the baseline intervention allocation to the intervention result checking section 41 and the intervention result saving section 42. The intervention result analyzing section 40 also outputs actual intervention results to the evaluation section 43 for the offline evaluation method and the evaluation result saving section 44 for the offline evaluation method. At that time, the evaluation result saving section 44 for the offline evaluation method is fed with the actual intervention results coupled to the data used for the offline evaluation, saved in the model offline evaluation result saving section 27, the offline evaluated value provided by each OPE, and the like.

To have the operator-side staff member check the intervention results, the intervention result checking section 41 presents the comparison result of the comparison between the model intervention allocation and the baseline intervention allocation, analyzed by the intervention result analyzing section 40.

The intervention result saving section 42 saves the actual intervention results fed from the intervention result analyzing section 40.

The evaluation section 43 for the offline evaluation method evaluates each OPE method on the basis of the actual intervention results fed from the intervention result analyzing section 40. That is, the evaluation section 43 for the offline evaluation method evaluates the offline evaluated value provided by each OPE using data regarding the users on whom the intervention allocation provided by the model has been performed and data regarding the users on whom the intervention allocation based on the baseline has been performed. Note that the data regarding the users on whom the intervention allocation provided by the model has been performed is hereinafter referred to as the data regarding the users to whom the model is applied and that the data regarding the users on whom the intervention allocation based on the baseline has been performed is hereinafter referred to as the data regarding the users to whom the baseline is applied.

The evaluation section 43 for the offline evaluation method outputs, to the evaluation result saving section 44 for the offline evaluation method, the data regarding the users to whom the model is applied, the data regarding the users to whom the baseline is applied, and evaluation results for the evaluated values provided by the OPEs, the results being obtained using each of the data.

The evaluation result saving section 44 for the offline evaluation method saves the data regarding the users to whom the model is applied, the data regarding the users to whom the baseline is applied, and the evaluation results for the evaluated values provided by the OPEs, the results being obtained using each of the data, the data and results being fed from the evaluation section 43 for the offline evaluation method. Furthermore, the evaluation result saving section 44 for the offline evaluation method saves data including the actual intervention results fed from the intervention result analyzing section 40 and coupled to the data saved in the model offline evaluation result saving section 27.

The training section 45 for the offline evaluation model trains the offline evaluation model using the data saved in the evaluation result saving section 44 for the offline evaluation method. The training section 45 for the offline evaluation method outputs the learned offline evaluation model to the model offline evaluating section 26.

### <Processing Example of Intervention Processing System>

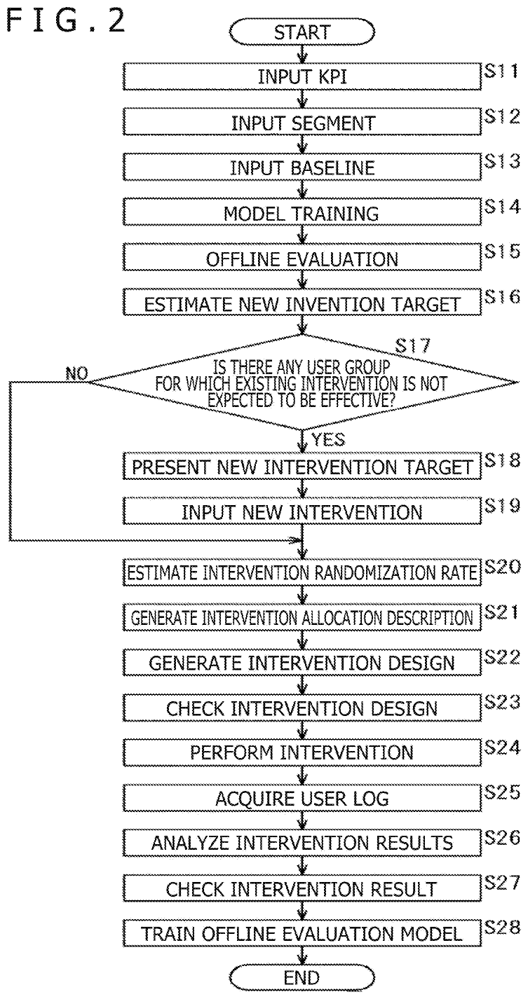

FIG. 2 is a flowchart describing processing of the intervention processing system 11.

In step S11, in response to operation of the operator-side staff member, the KPI input section 21 receives, as an input, a KPI to be optimized by intervention and the KPI to the model training section 24.

In step S12, in response to operation of the operator-side staff member, the segment input section 22 receives, as an input, a user segment to be optimized by the intervention, and outputs the user segment to the model training section 24.

In step S13, in response to the operation of the operator-side staff member, the baseline input section 23 receives, as an input, a baseline and outputs the baseline to the model training section 24.

In step S14, the model training section 24 trains the model using the user log saved in the user log saving section 39 and the intervention information saved in the intervention saving section 31, and outputs a new intervention allocation as a learning result.

The model training section 24 outputs the learned model to the model saving section 25. The model training section 24 outputs, to the model offline evaluating section 26, the learned model and the data used for training of the model.

In step S15, the model offline evaluating section 26 performs offline evaluation on the model fed by the model training section 24. The data used for the offline evaluation, the predicted values for the expected KPIs provided by the OPEs, and the like are output to the model offline evaluation result saving section 27 and the intervention randomization rate estimating section 32. The calculated offline evaluated value is output to the new intervention target estimating section 28.

In step S16, on the basis of the offline evaluated value fed from the model offline evaluating section 26, the new intervention target estimating section 28 estimates whether or not there is any user for whom the existing intervention is not expected to be effective.

In step S17, on the basis of an estimation result in step S16, the new intervention target estimating section 28 determines whether or not there is any user for whom the existing intervention is not expected to be effective. In a case where the new intervention target estimating section 28 determines, in step S17, that there is a user for whom the existing intervention is not expected to be effective, the processing proceeds to step S18. In this case, the new intervention target estimating section 28 extracts the user feature amount of the user for whom the existing intervention is not expected to be effective and outputs the extracted user feature amount to the new intervention target presenting section 29.

In step S18, on the basis of the user feature amount fed from the new intervention target estimating section 28, the new intervention target presenting section 29 presents the user for whom the existing intervention is not expected to be effective, and encourages the operator-side staff member to add a new intervention targeted at the user.

In step S19, in response to operation of the operator-side staff member, the new intervention input section 30 receives, as an input, information regarding the new intervention, and outputs the input intervention information to the intervention saving section 31 and the intervention design generating section 34. The intervention saving section 31 saves the intervention information fed from the new intervention input section 30.

In step S17, in a case where the new intervention target estimating section 28 determines that there is no user for whom the existing intervention is not expected to be effective, the processing in steps S18 and S19 is skipped, and the processing proceeds to step S20.

In step S20, the intervention randomization rate estimating section 32 estimates the optimum rate of the random intervention with users. The intervention randomization rate estimating section 32 outputs the estimated rate of the random intervention with users to the intervention allocation description generating section 33 along with the data used for the offline evaluation fed from the model offline evaluating section 26, the predicted values for the expected KPIs provided by the OPEs, and the like.

In step S21, the intervention allocation description generating section 33 references the rate of the random intervention with users, and generates an intervention allocation description including comparison information between the baseline and the model for the predicted values for the intervention and expected KPIs. The intervention allocation description generating section 33 outputs, to the intervention design generating section 34, the data used for the offline evaluation and the rate of the random intervention with users, which are fed from the intervention randomization rate estimating section 32, and the generated intervention allocation description.

In step S22, the intervention design generating section 34 generates final intervention design information on the basis of the data used for the offline evaluation, the predicted value for the expected KPI provided by each OPE, the rate of the random intervention with users, and the intervention allocation description, which are fed from the intervention allocation description generating section 33.

The intervention design generating section 34 outputs the generated intervention design information to the intervention design saving section 35 and the intervention section 37. The intervention design generating section 34 also outputs the generated intervention design information to the intervention design checking section 36.

In step S23, to have the operator-side staff member check, before the actual intervention, the intervention design information fed from the intervention design generating section 34, the intervention design checking section 36 presents the intervention design information.

In step S24, the intervention is performed on the user, that is, the display section of the user terminal on the basis of the intervention design information generated by the intervention design generating section 34.

In step S25, the user state acquiring section 38 acquires, from the UI of the user terminal or the sensor, information indicating behavior taken by the user as a result of the intervention, and outputs the acquired information to the user log saving section 39.

In step S26, the intervention result analyzing section 40 references the user log in the user log saving section 39 to compare the model intervention allocation with the baseline intervention allocation, and analyzes intervention results by determination of whether or not the actual KPI value has improved, and the like. The intervention result analyzing section 40 outputs the comparison result of the comparison between the model and the baseline to the intervention result checking section 41 and the intervention result saving section 42.

In step S27, to have the operator-side staff member check the intervention results, the intervention result checking section 41 presents the comparison result of the comparison performed between the model intervention allocation and the baseline intervention allocation, by the intervention result analyzing section 40.

In step S28, the evaluation section 43 for the offline evaluation method and the training section 45 for the offline evaluation model evaluate the offline evaluation method and train the offline evaluation model.

That is, the evaluation section 43 for the offline evaluation method evaluates the offline evaluated value provided by each OPE on the basis of the actual intervention results fed from the intervention result analyzing section 40.

The evaluation section 43 for the offline evaluation method outputs the data regarding the users to whom the model is applied, the data regarding the users to whom the baseline is applied, and the evaluation results for the offline evaluated values provided by the OPEs, the results being obtained using each of the data. The actual intervention results fed from the intervention result analyzing section 40 are coupled to the data used for the offline evaluation, which is saved in the model offline evaluation result saving section 27, the offline evaluated value provided by each OPE, and the like, and the data resulting from the coupling is fed to the evaluation result saving section 44 for the offline evaluation method.

The evaluation result saving section 44 for the offline evaluation method saves the data regarding the users to whom the model is applied, the data regarding the users to whom the baseline is applied, and the evaluation results for the offline evaluated values provided by the OPEs, the results being obtained using each of the data, the data and results being fed from the evaluation section 43 for the offline evaluation method. The evaluation result saving section 44 for the offline evaluation method saves data including the actual intervention results fed from the intervention result analyzing section 40, the data being coupled to the data used for the offline evaluation, which is saved in the model offline evaluation result saving section 27, the offline evaluated value provided by each OPE, and the like.

The training section 45 for the offline evaluation model trains the offline evaluation model using the data saved in the evaluation result saving section 44 for the offline evaluation method. The training section 45 for the offline evaluation model outputs the learned offline evaluation model to the model offline evaluating section 326.

Note that the offline evaluation model trained in step S28 is used for the offline evaluation in the next step S15. Therefore, repetition of the processing described above with reference to FIG. 2 increases the amount of data saved in the evaluation result saving section 44 for the offline evaluation method, improving the accuracy of the offline evaluation model.

### <Three Main Elements of Present Technology>

Now, three main elements of the present technology will be described in order. The three elements include estimation of the intervention randomization rate in step S16, generation of an intervention allocation description in step S21, and training of the offline evaluation model in step S28, in FIG. 2.

### <Estimation of Intervention Randomization Rate>

First, the estimation of the intervention randomization rate in step S16 in FIG. 2 will be described.

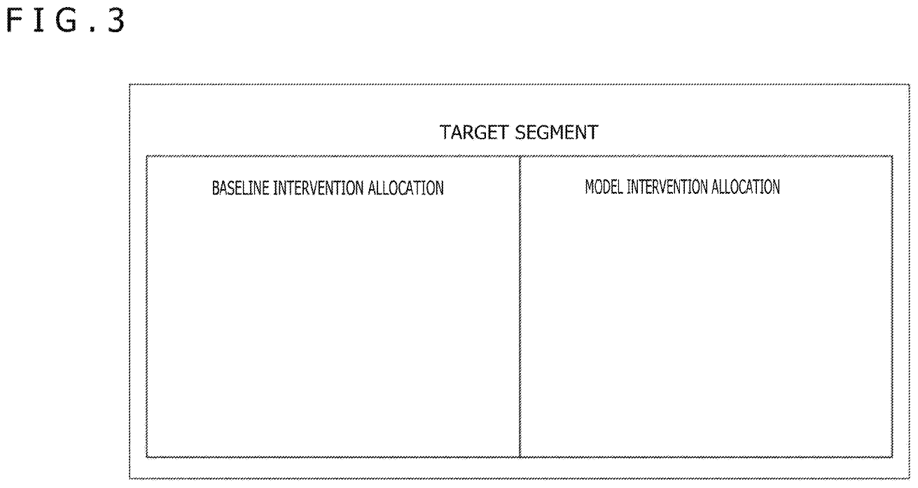

FIG. 3 is a diagram illustrating an example in which the baseline intervention allocation and the model intervention allocation are directly applied to the users in the target segment.

The baseline intervention allocation and the intervention allocation provided by the model are generally deterministic.

For example, a case is considered in which one of a coupon A and a coupon B is provided to each user (intervention). In this case, when the probability of the intervention allocation to each user is “coupon A: 100%, coupon B: 0%” or “coupon A: 0%, coupon B: 100%,” these intervention allocations are deterministic.

That is, FIG. 3 illustrates both the baseline intervention allocation and the model intervention allocation to the users in the target segment being deterministic. In other words, the probability of the intervention allocations to each user is “coupon A: 100%, coupon B: 0%” or “coupon A: 0%, coupon B: 100%.”

On the other hand, in a case where the intervention allocation to each used is not 0% or 100%, these intervention allocations are probabilistic.

Therefore, in a case where the intervention is performed with the deterministic intervention allocations as depicted in FIG. 3, collected data has been subjected to a deterministic intervention. Accordingly, the data is not suitable for training and evaluation of a model using causal inference.

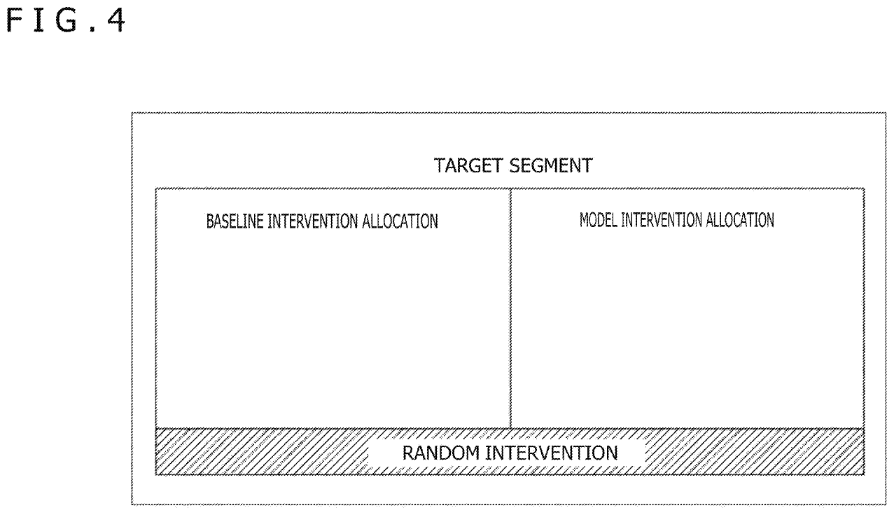

Thus, as depicted in a lower part of FIG. 4, a random intervention is added to some of the users in the target segment to implement a probabilistic intervention allocation.

FIG. 4 is a diagram illustrating an example in which the random intervention is added to the baseline intervention allocation and the model intervention allocation.

In FIG. 4, the random intervention is added to some of the users in the target segment.

In this case, a larger number of users subjected to the added intervention, that is, the random intervention, correspond to data more suitable for the causal inference. On the other hand, in this case, a reduced number of users are subjected to direct application of the baseline intervention allocation and the model intervention allocation, and thus the KPI is more likely to fail to exhibit significant improvement when the baseline intervention allocation is compared with the model intervention allocation.

Thus, the intervention randomization rate estimating section 32 estimates an optimum sample size of the users to be subjected to the random intervention as depicted in FIG. 4.

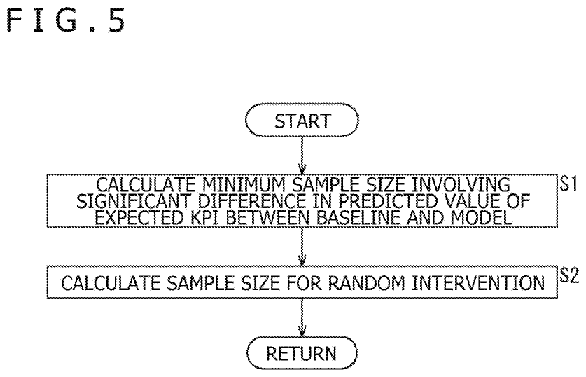

FIG. 5 is a flowchart for describing processing for estimating the intervention randomization rate in step S16 in FIG. 2.

In step S51, the intervention randomization rate estimating section 32 calculates the minimum sample size involving a significant difference in the predicted value for the expected KPI between the baseline and the model.

At that time, on the basis of the offline evaluation results for each of the baseline intervention allocation and the model intervention allocation, the intervention randomization rate estimating section 32 calculates a sample size expected to involve a significant difference in the predicted value for the expected KPI when a statistical test is conducted.

Here, a t-test is used as an example of the statistical test. Specifying a power, a significance level, and an effect size causes a required sample size to be calculated, but as general values, power=0.8 and significance level=0.05 are set. The effect size can be calculated on the basis of the offline evaluation results (predicted value for the expected KPI for each of the baseline and the model), and thus the sample size is calculated.

In step S52, the intervention randomization rate estimating section 32 calculates the sample size for the random intervention as depicted in FIG. 4.

At that time, the intervention randomization rate estimating section 32 subtracts, from the number of users in the target segment, the minimum sample size involving a significant difference in the predicted value for the expected KPI between the baseline and the model. This allows the sample size of users subjected to the random intervention to be calculated.

### <Generation of Intervention Allocation Description>

Now, the generation of an intervention allocation description in step S21 in FIG. 2 will be described.

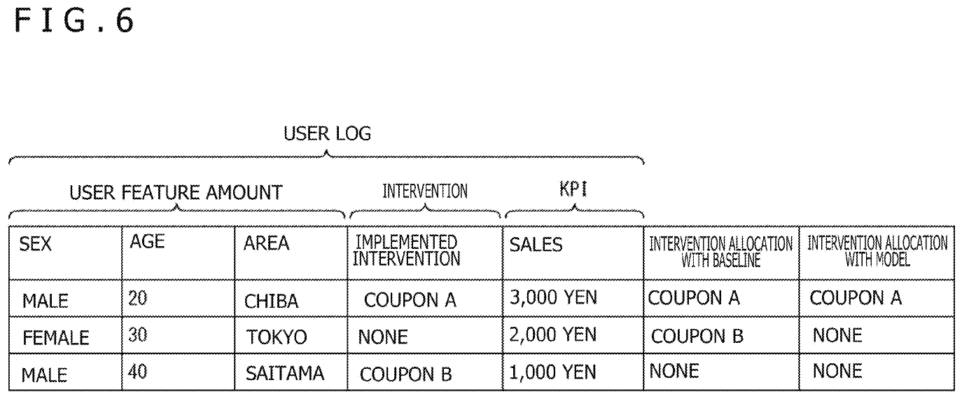

FIG. 6 is a diagram illustrating an example of the user log saved in the user log saving section 39 and the intervention allocation for the user log.

In FIG. 6, the user log includes the user feature amount, the intervention, and the measured KPI value. The user feature amount includes “sex,” “age,” and “area.” The intervention includes “provide coupon A,” “provide coupon B,” and “provide nothing.” The KPI is “sales.”

A case is considered in which, for each user feature amount in the user log, an intervention allocation based on the baseline is present and an intervention allocation provided by the model is generated.

In the first data, “sex” is male, “age” is twenties, “area” is Chiba, “intervention” is a coupon A, and “sales” is 3,000 yen. The baseline intervention allocation for the first data is the coupon A, and the model intervention allocation for the first data is the coupon A.

In the second data, “sex” is female, “age” is thirties, “area” is Tokyo, “intervention” is none, and “sales” is 2,000 yen. The baseline intervention allocation for the second data is a coupon B, and the model intervention allocation for the second data is none.

In the third data, “sex” is male, “age” is forties, “area” is Saitama, “intervention” is the coupon B, and “sales” is 1,000 yen. The baseline intervention allocation for the third data is none, and the model intervention allocation for the third data is none.

The intervention allocation description generating section 33 is configured as described above. In a case where a user log and an intervention allocation are present, the intervention allocation description generating section 33 generates an intervention allocation description indicating “how a new intervention allocation provided by the model differs from the baseline intervention allocation and as a result what level of effect is expected from the new intervention allocation provided by the model.”

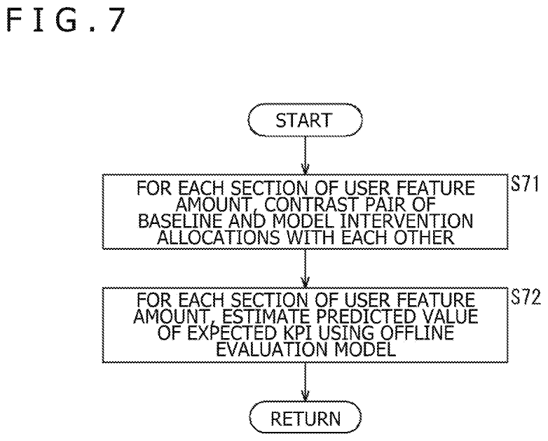

FIG. 7 is a flowchart for describing the generation of an intervention allocation description in step S21 in FIG. 2.

In step S71, the intervention allocation description generating section 33 associates a baseline intervention allocation with a model intervention allocation as a pair for each segment of the user feature amount.

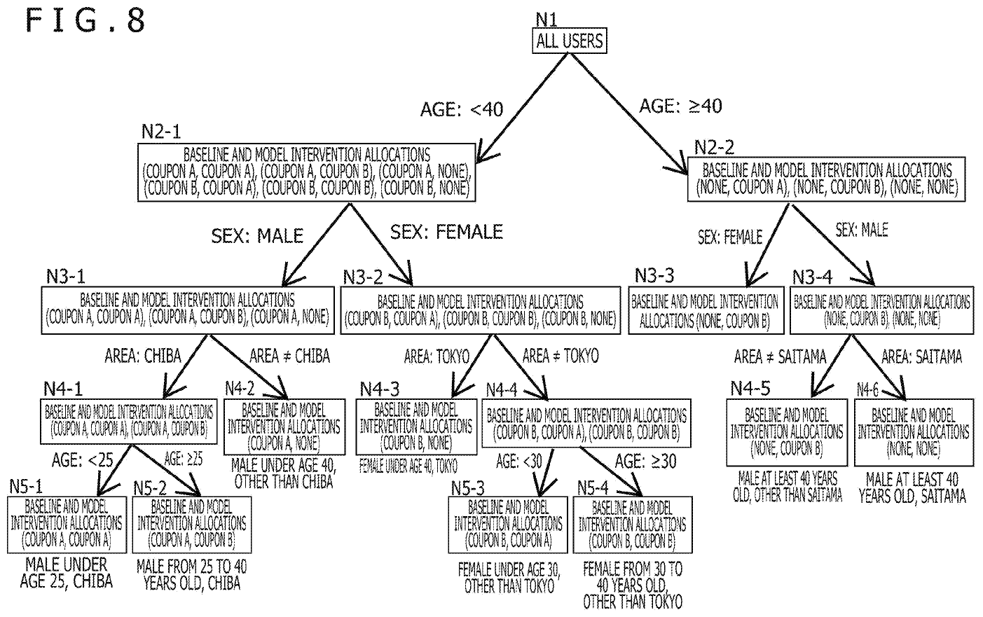

That is, the intervention allocation description generating section 33 considers the pair of the baseline intervention allocation and the model intervention allocation as one variable and determines the correspondence relation between the variable and the user feature amount. At that time, for example, a decision tree is used that will be described below with reference to FIG. 8. In this case, the decision tree is learned that infers the pair of the baseline intervention allocation and the model intervention allocation on the basis of the user feature amount.

FIG. 8 is a diagram illustrating the decision tree inferring the pair of the baseline intervention allocation and the model intervention allocation on the basis of the user feature amount.

FIG. 8 depicts the baseline and model intervention allocations at each node of the decision tree. Arrows represent conditional branches for samples, and conditions for classifying the samples are depicted on the arrows.

At a node N1 in the uppermost stage, samples with a user feature amount “age” of less than 40 are branched into a node N2-1, whereas samples with a user feature amount “age” of 40 or more are branched into a node N2-2.

At the node N2-1, the baseline and model intervention allocation are (coupon A, coupon A), (coupon A, coupon B), (coupon A, none), (coupon B, coupon A), (coupon B, coupon B), or (coupon B, none). At the node N2-1, samples with a user feature amount “sex” of male are branched into a node N3-1, whereas samples with a user feature amount “sex” of female are branched into a node N3-2.

At the node N2-2, the baseline and model intervention allocations are (none, coupon A), (none, coupon B), or (none, none). At the node N2-2, samples with a user feature amount “sex” of female are branched into a node N3-3, whereas samples with a user feature amount “sex” of male are branched into a node N3-4.

At the node N3-1, the baseline and model intervention allocations are (coupon A, coupon A), (coupon A, coupon B), or (coupon A, none). At the node N3-1, samples with a user feature amount “area” of Chiba are branched into a node N4-1, whereas samples with a user feature amount “area” of other than Chiba are branched into a node N4-2.

At the node N3-2, the baseline and model intervention allocations are (coupon B, coupon A), (coupon B, coupon B), or (coupon B, none). At the node N3-2, samples with a user feature amount “area” of Tokyo are branched into a node N4-3, whereas samples with a user feature amount “area” of other than Tokyo are branched into a node N4-4.

At the node N3-3, the baseline and model intervention allocations are (none, coupon A). At the node N3-3, the samples are not branched. Specifically, the baseline and model intervention allocations to samples with a user feature amount “age” of less than 40 and a user feature amount “sex” of female are (none, coupon A) depicted at the node N3-3.

At the node N3-4, the baseline and model intervention allocations are (none, coupon B) or (none, none). At the node N3-4, samples with a user feature amount “area” of other than Saitama are branched into a node N4-5, whereas samples with a user feature amount “area” of Saitama are branched into a node N4-6.

At the node N4-1, the baseline and model intervention allocations are (coupon A, coupon A) or (coupon A, coupon B). At the node N4-1, samples with a user feature amount “age” of less than 25 are branched into a node N5-1, whereas samples with a user feature amount “age” of 25 or more are branched into a node N5-2.

At the node N4-2, the baseline and model intervention allocations are (coupon A, none). At the node N4-2, the samples are not branched. Specifically, the baseline and model intervention allocations to samples with a user feature amount “age” of less than 40, a user feature amount “sex” of male, and a user feature amount “area” of other than Chiba are (coupon A, none) depicted at the node N4-2.

At the node N4-3, the baseline and model intervention allocations are (coupon B, none). At the node N4-3, the samples are not branched. Specifically, the baseline and model intervention allocations to samples with a user feature amount “age” of less than 40, a user feature amount “sex” of female, and a user feature amount “area” of Tokyo are (coupon B, none) depicted at the node N4-3.

At the node N4-4, the baseline and model intervention allocations are (coupon B, coupon A) or (coupon B, coupon B). At the node N4-4, samples with a user feature amount “age” of less than 30 are branched into a node N5-3, whereas samples with a user feature amount “age” of 30 or more are branched into a node N5-4.

At the node N4-5, the baseline and model intervention allocations are (none, coupon B). At the node N4-5, the samples are not branched. Specifically, the baseline and model intervention allocations to samples with a user feature amount “age” of 40 or more, a user feature amount “sex” of male, and a user feature amount “area” of other than Saitama are (none, coupon B) depicted at the node N4-5.

At the node N4-6, the baseline and model intervention allocations are (none, none). At the node N4-6, the samples are not branched. Specifically, the baseline and model intervention allocations to samples with a user feature amount “age” of 40 or more, a user feature amount “sex” of male, and a user feature amount “area” of Saitama are (none, none) depicted at the node N4-6.

At the node N5-1, the baseline and model intervention allocations are (coupon A, coupon A). At the node N5-1, the samples are not branched. Specifically, the baseline and model intervention allocations to samples with a user feature amount “age” of less than 25, a user feature amount “sex” of male, and a user feature amount “area” of Chiba are (coupon A, coupon A) depicted at the node N5-1.

At the node N5-2, the baseline and model intervention allocations are (coupon A, coupon B). At the node N5-2, the samples are not branched. Specifically, the baseline and model intervention allocations to samples with a user feature amount “age” of 25 or more and less than 40, a user feature amount “sex” of male, and a user feature amount “area” of Chiba are (coupon A, coupon B) depicted at the node N5-2.

At the node N5-3, the baseline and model intervention allocations are (coupon B, coupon A). At the node N5-3, the samples are not branched. Specifically, the baseline and model intervention allocations to samples with a user feature amount “age” of less than 30, a user feature amount “sex” of female, and a user feature amount “area” of other than Tokyo are (coupon B, coupon A) depicted at the node N5-3.

At the node N5-4, the baseline and model intervention allocations are (coupon B, coupon B). At the node N5-4, the samples are not branched. Specifically, the baseline and model intervention allocations to samples with a user feature amount “age” of 30 or more and less than 40, a user feature amount “sex” of female, and a user feature amount “area” of other than Tokyo are (coupon B, coupon B) depicted at the node N5-4.

Now, referring back to FIG. 7, in step S72, the intervention allocation description generating section 33 estimates the predicted value for the expected KPI for each segment of the user feature amount using the offline evaluation model.

That is, for the user feature amounts “male, age of 25 or more and less than 40, Chiba” at the node 5-2 in FIG. 8, the intervention allocation description generating section 33 uses the offline evaluation model to estimate the predicted value for the expected KPI obtained in a case where the coupon A is provided on the basis of the baseline intervention allocation and to estimate the predicted value for the expected KPI obtained in a case where the coupon B is provided on the basis of the model intervention allocation.

Thus, the intervention allocation description generating section 33 can generate, for each user feature amount, an intervention allocation description indicating how the intervention allocation provided by the model differs from the baseline intervention allocation and, as a result, what level of effect can be expected from the intervention allocation provided by the model.

The intervention design checking section 36 can be caused to present this result to have the operator-side staff member check the result.

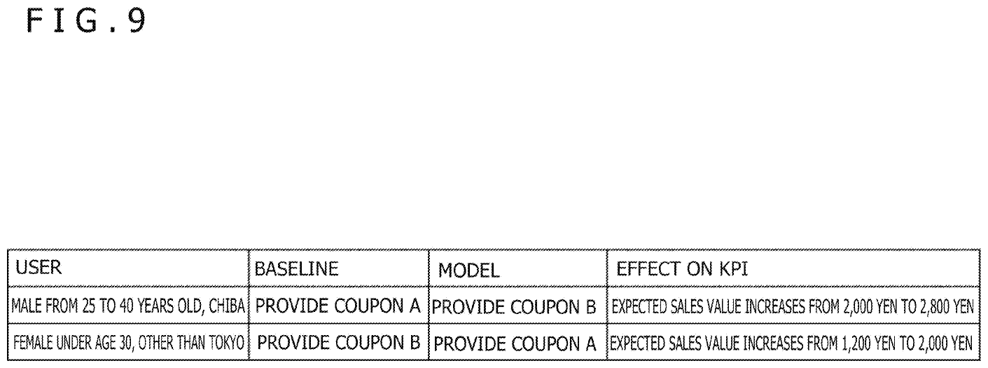

FIG. 9 is a diagram illustrating an example of a UI related to the intervention allocation description.

In the UI in FIG. 9, “user” indicates the user feature amounts, “baseline” indicates the baseline intervention allocation, “model” indicates the model intervention allocation, and “effect on KPI” indicates what level of effect on the KPI is expected in a case where the baseline intervention allocation is changed to the model intervention allocation.

The first intervention allocation description indicates that, for the “user” of “male, age of from 25 to 40, Chiba,” the “effect on the KPI” can be expected in which the “expected sales value increases from 2,000 yen to 2,800 yen” in a case where the “baseline” intervention allocation for “provide coupon A” is changed to the “model” intervention allocation for “provide coupon B.”

The second intervention allocation description indicates that, for the “user” of “female, age of less than 30, other than Tokyo,” the “effect on the KPI” can be expected in which the “expected sales value increases from 1,200 yen to 2,000 yen” in a case where the “baseline” intervention allocation for “provide coupon B” is changed to the “model” intervention allocation for “provide coupon A.”

For example, when the intervention design checking section 36 presents the UI in FIG. 9, the operator-side staff member can check the intervention allocation description.

### <Details of Offline Evaluation Model>

Now, the training of the offline evaluation model in step S18 in FIG. 2 will be described.

In a case where offline evaluation is performed, the intervention allocation actually applied to the data generally often differs from the intervention allocation to be evaluated. For example, the intervention allocations differ from each other in seasonality (collection month) or sample size. To determine the true KPI, which is a measured KPI value for the result of implementation of the intervention allocation to be evaluated, the intervention allocation to be evaluated needs to be actually performed online.

For convenience of description, the names of various kinds of data are defined below. “Evaluation data” is defined as data to which an intervention allocation different from the intervention allocation to be evaluated. “True data” is defined as data to which the intervention allocation to be actually evaluated is applied online.

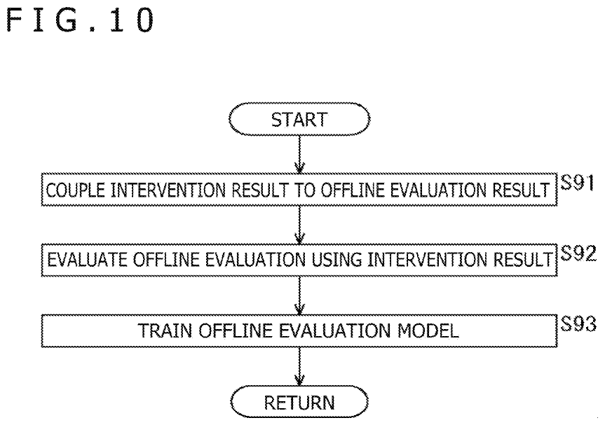

FIG. 10 is a flowchart for describing the training of the offline evaluation model in step S18 in FIG. 2.

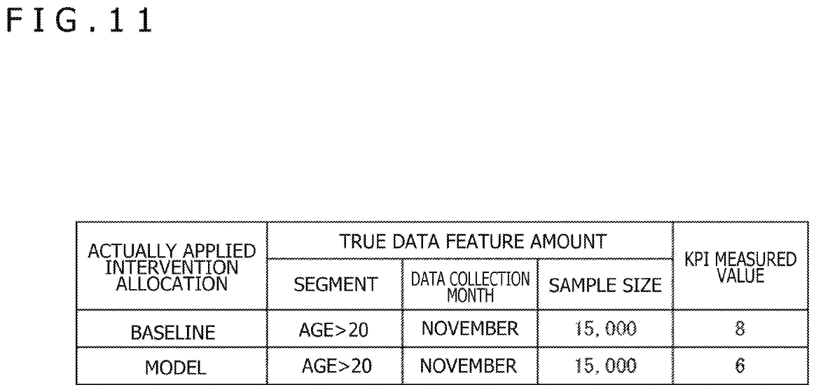

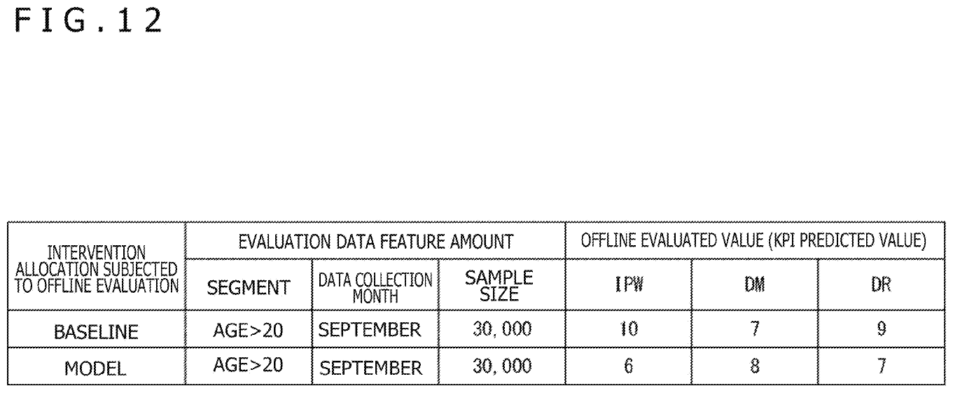

In step S91, the result of actual intervention (FIG. 11) fed from the intervention result analyzing section 40 is coupled to the offline evaluation result (FIG. 12) saved in the model offline evaluation result saving section 27, and the resultant data is fed to the evaluation result saving section 44 for the offline evaluation method.

FIG. 11 is a diagram illustrating an example of data of the result of the actual intervention fed from the intervention result analyzing section 40.

FIG. 11 illustrates an example in which the data feature amounts of the true data used (hereinafter referred to as the true data feature amounts) include “segment,” “data collection month,” and “sample size.”

For the data of the actually applied baseline intervention allocation, the true data feature amounts include the segment “age>20,” the data collection month “November,” and the sample size “15,000,” and the measured KPI value for the baseline intervention allocation is “8.”

For the data of the actually applied model intervention allocation, the true data feature amounts include the segment “age>20,” the data collection month “November,” and the sample size “15,000,” and the measured KPI value for the baseline intervention allocation is “6.”

FIG. 12 is a diagram illustrating an example of data saved in the model offline evaluation result saving section 27.

The model offline evaluation result saving section 27 saves the data feature amounts for offline evaluation and the offline evaluated value (predicted value for the expected KPI (represented as the predicted KPI value in the diagram. This also applies to the subsequent diagrams.))

FIG. 12 illustrates an example in which the data feature amounts of the evaluation data used (hereinafter referred to as the evaluation data feature amounts) include “segment,” “data collection month,” and “sample size,” and in which the offline evaluation methods used include IPW, DM, and DR.

For the data of the offline evaluated baseline intervention allocation, the evaluation data feature amounts include the segment “age>20,” the data collection month “September,” and the sample size “30,000,” and the offline evaluated values for IPW, DM, and DR are “10, 7, 9.”

For the data of the offline evaluated model intervention allocation, the evaluation data feature amounts include the segment “age>20,” the data collection month “September,” and the sample size “30,000,” and the offline evaluated values for IPW, DM, and DR are “6, 8, 7.”

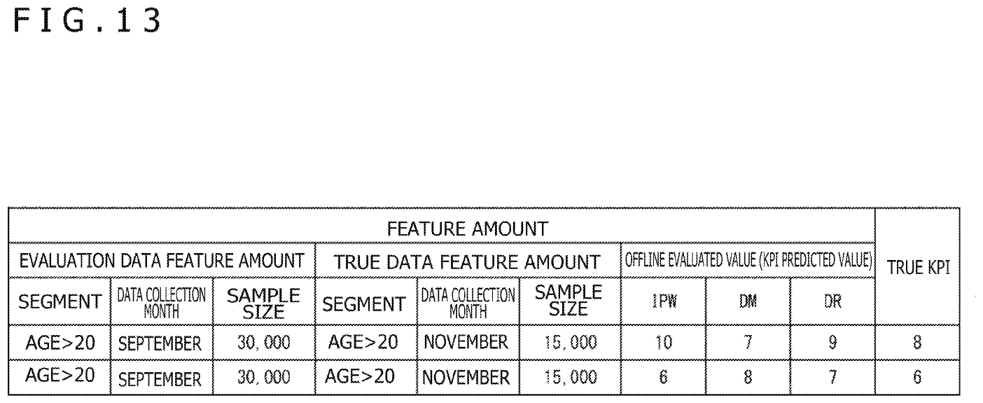

In step S91 in FIG. 10, the online intervention result depicted in FIG. 11 is coupled to the offline evaluated value depicted in FIG. 12, and thus as depicted in FIG. 13, a correspondence table for the true KPI and the data feature amount and offline evaluated value.

FIG. 13 is a diagram illustrating an example of data including the intervention result coupled to the offline evaluation result (correspondence table).

FIG. 13 depicts, as data feature amounts, data including amount, and the offline evaluated value, and also depicts the true KPI. In FIG. 13, for example, the first data is data corresponding to application of the baseline intervention allocation, and the second data is data corresponding to application of the model intervention allocation.

For the feature amounts of the first data, the evaluation data feature amounts include the segment “age>20,” the data collection month “September,” and the sample size “30,000,” the true data feature amounts include the segment “age>20,” the data collection month “November,” and the sample size “15,000,” and the offline evaluated values for IPW, DM, and DR are “10, 7, 9.” The true KPI for the first data is “8.”

For the feature amounts of the second data, the evaluation data feature amounts include the segment “age>20,” the data collection month “September,” and the sample size “30,000,” the true data feature amounts include the segment “age>20,” the data collection month “November,” and the sample size “15,000,” and the offline evaluated values for IPW, DM, and DR are “6, 8, 7.” The true KPI for the second data is “6.”

Referring back to step S92, the evaluation section 43 for the offline evaluation method evaluates the offline evaluation method using the actual intervention result (FIG. 11) fed from the intervention result analyzing section 40.

The offline evaluation method is evaluated using a method described in a cited document 1 (“YUTA SAITO, TAKUMA UDAGAWA, KEI TATENO,” “Data-Driven Off-Policy Estimator Selection: An Application in User Marketing on An Online Content Delivery Servic,” RecSys2020 Workshop, REVEAL 2020: Bandit and Reinforcement Learning from User Interactions, Jul. 27, 2020).

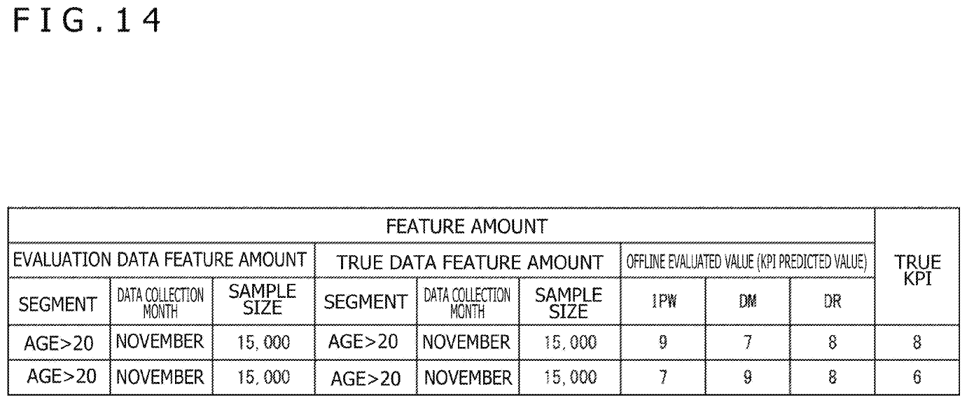

Evaluation of the offline evaluation method allows acquisition of data to which the baseline intervention allocation is applied and data to which the model intervention allocation is applied (FIG. 14). This enables one of the data to be treated as evaluation data, while enabling the other to be treated as true data, allowing the offline evaluated value to be compared with the true KPI.

FIG. 14 is a diagram illustrating an example of data used for evaluation of the offline evaluation method using intervention results.

FIG. 14 depicts, as data feature amounts, data including amount, and an online evaluated value, and also depicts the true KPI. In FIG. 14, for example, the first data is data corresponding to application of the baseline intervention allocation, and the second data is data corresponding to application of the model intervention allocation.

For the feature amounts of the first data, the evaluation data feature amounts include the segment “age>20,” the data collection month “November,” and the sample size “15,000,” the true data feature amounts include the segment “age>20,” the data collection month “November,” and the sample size “15,000,” and the offline evaluated values for IPW, DM, and DR are “9, 7, 8.” The true KPI for the first data is “8.”

For the feature amounts of the second data, the evaluation data feature amounts include the segment “age>20,” the data collection month “November,” and the sample size “15,000,” the true data feature amounts include the segment “age>20,” the data collection month “November,” and the sample size “15,000,” and the offline evaluated values for IPW, DM, and DR are “7, 9, 8.” The true KPI for the second data is “6.”

The evaluation result saving section 44 for the offline evaluation method saves the data in FIG. 13 fed to the evaluation result saving section 44 after being subjected to coupling between the intervention result analyzing section 40 and the model offline evaluation result saving section 27, and saves the data in FIG. 14 fed from the evaluation section 43 for the offline evaluation method.

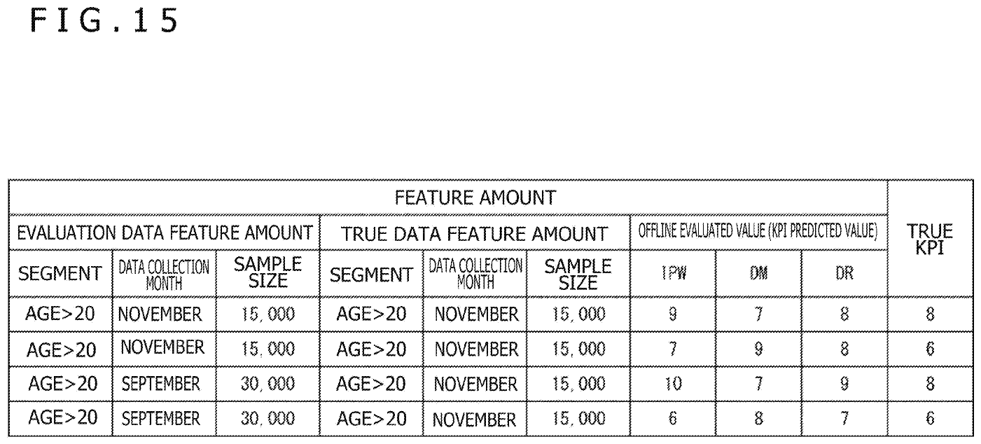

FIG. 15 is a diagram illustrating an example of data saved in the evaluation result saving section 44 for the offline evaluation method.

The first data depicted in FIG. 15 is the first data in FIG. 14, and the second data depicted in FIG. 15 is the second data in FIG. 14. The third data depicted in FIG. 15 is the first data in FIG. 13, and the fourth data depicted in FIG. 15 is the second data in FIG. 13.

Referring back to FIG. 10, in step S93, the training section 45 for the offline evaluation model trains the offline evaluation model using the data (FIG. 15) saved in the evaluation result saving section 44 for the offline evaluation method.

The offline evaluation model is trained using the evaluation data feature amount, the true data feature amount, and the offline evaluated value as feature amounts and using the true KPI as an objective variable. For the training, supervised learning, for example, linear regression, a regression tree, a neutral network, or the like is used.

The offline evaluation model trained here is used during the next offline evaluation performed by the model offline evaluating section 26. In this case, assumed online intervention information is used as the true data feature amount.

### <2. Variations>

### <Variation of Intervention Randomization Rate Estimation>

The operator-side staff member may adjust the randomization rate estimated by the intervention randomization rate estimating section 32.

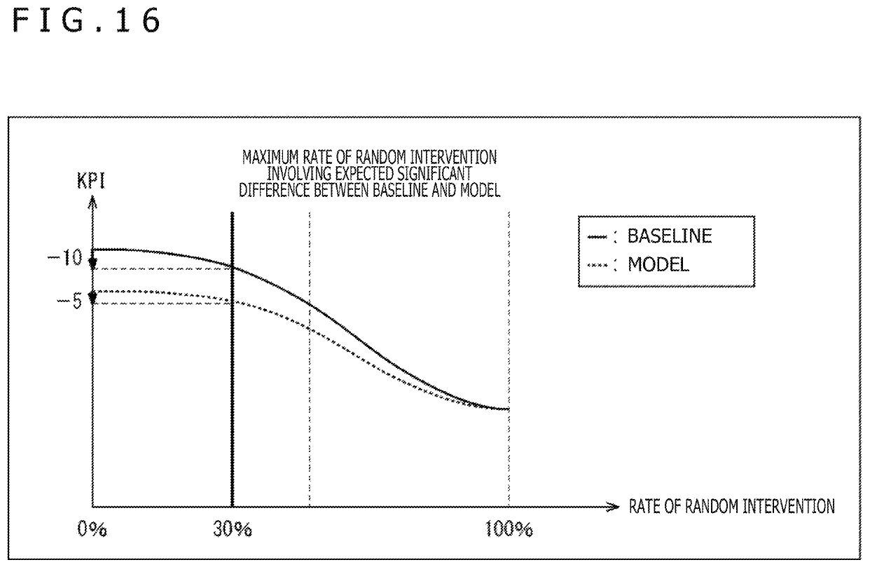

Additionally, at that time, by using the offline evaluation model to calculate (the predicted value for) the expected KPI corresponding to the randomization rate, the operator-side staff member can also be presented with the predicted value for the expected KPI and a risk corresponding to the randomization rate, as depicted in FIG. 16. Here, the risk indicates the estimated rate of decrease in KPI compared to the KPI obtained in a case where no random intervention is performed.

FIG. 16 is a diagram illustrating an example of a UI that can adjust the rate of random intervention.

In FIG. 16, the horizontal axis indicates the rate of random intervention, and the vertical axis indicates the KPI corresponding to the rate of random intervention. A solid graph represents a baseline KPI, whereas a graph of an alternate long and short dash line represents a model KPI. In FIG. 16, the KPI represents the predicted value for the expected KPI.

The UI in FIG. 16 displays an example in which an adjustment bar for the rate of random intervention, the rate of random intervention is positioned at 30%. In this case, the vertical axis indicates the risk that the KPI obtained in a case where the rate of random intervention is 30% decreases by 10 for the baseline and by 5 for the model compared to the KPI obtained in a case where the rate of random intervention is 0%.

Additionally, the UI in FIG. 16 indicates that 50% is the maximum rate of random intervention that can be expected to make a significant difference between the baseline and the model.

In the UI in FIG. 16, by sliding the adjustment bar for the rate of random intervention between 0% and 50%, the corresponding risk is presented. Accordingly, the operator-side staff member can check the risk. Thus, the operator-side staff member can determine the rate of random intervention depending on an allowable risk.

### <Variation of Generation of Intervention Allocation Description>

In the example described above, the intervention allocation description is applied to the offline evaluation result. However, the intervention allocation description can also be applied to an online evaluation result.

In this case, the calculation of the predicted value for the expected KPI using the offline evaluation model is replaced with an online actual KPI value. Such processing is executed by the intervention result analyzing section 40 to enable the intervention result checking section 41 to make a presentation to the operator-side staff member.

Additionally, the intervention allocation description may be individually provided on a per-user basis. In this case, the model used estimates a lift effect.

This enables the lift effect on each intervention to be estimated on a per-user basis, allowing information regarding the comparison of the KPI between the baseline and the model to be obtained on a per-user basis.

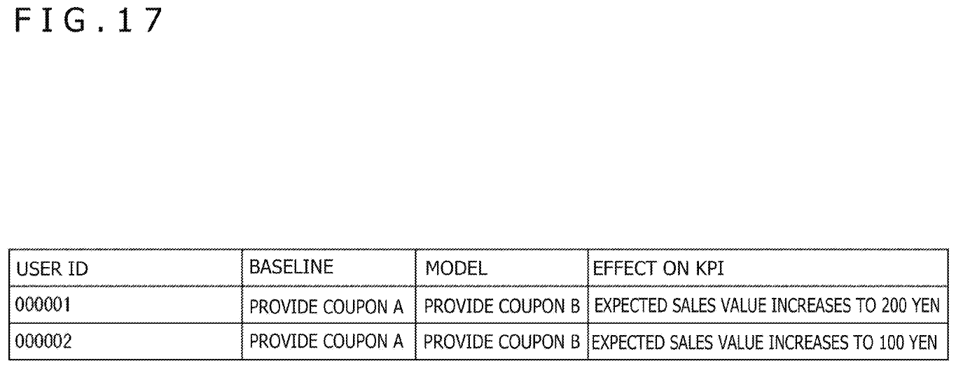

The intervention design checking section 36 may be caused to present this result to the operator-side staff member as depicted in FIG. 17.

FIG. 17 is a diagram illustrating an example of a UI presented by the intervention design checking section 36.

The UI in FIG. 17 displays the baseline intervention allocation, the model intervention allocation, and the effect on the KPI for each user with a respective user ID.

For a user with a user ID of “00001,” the baseline intervention allocation is “provide coupon A,” the model intervention allocation is “provide coupon B,” and the effect on the KPI is “expected sales value increases to 200 yen.”

For a user with a user ID of “00002,” the baseline intervention allocation is “provide coupon A,” the model intervention allocation is “provide coupon B,” and the effect on the KPI is “expected sales value increases to 100 yen.”

### <Variation of Training of Offline Evaluation Model>

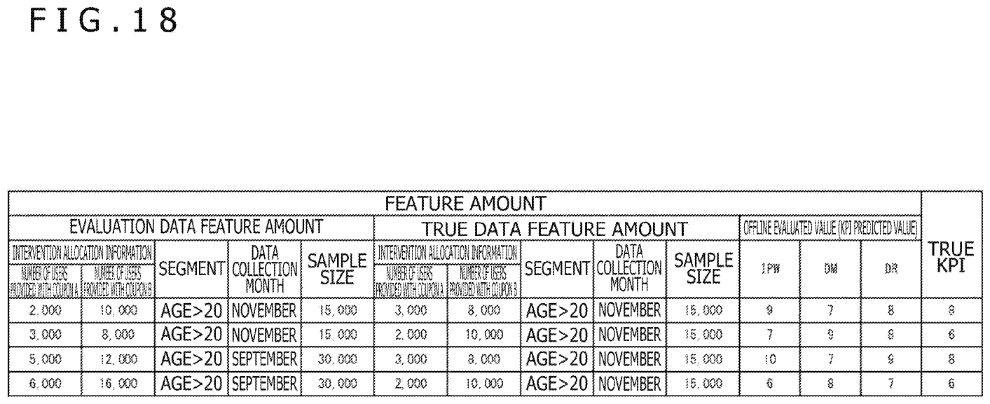

Feature amounts used to train the offline evaluation model may include not only user feature amounts but also intervention allocation information as depicted in FIG. 18. The intervention allocation information is, for example, the number of users on whom the intervention has been performed, the ratio of the number of users on whom the intervention has been performed to the total number of users, and the like.

FIG. 18 is a diagram illustrating an example of learning data for the offline evaluation model to which intervention allocation information is added.

Data in FIG. 18 differs from the data in FIG. 14 in that the data includes, as evaluation data feature amounts and true data feature amounts, not only the segment, the data collection month, and the sample size, but also intervention allocation information including the number of users to whom the coupon A is provided and the number of users to whom the coupon A is provided. Note that, in FIG. 18, for example, the first and third data are data to which the baseline intervention allocation is applied, and the second and fourth data are data to which the model intervention allocation is applied.

For the feature amounts of the first data, the evaluation data feature amounts include the number of users to whom the coupon A is provided “2,000,” the number of users to whom the coupon is provided “10,000,” the segment “age>20,” the data collection month “November,” and the sample size “15,000.” Additionally, the true data feature amounts include the number of users to whom the coupon A is provided “3,000,” the number of users to whom the coupon is provided “8,000,” the segment “age>20,” the data collection month “November,” and the sample size “15,000,” and the offline evaluated values for IPW, DM, and DR are “9, 7, 8.” The true KPI for the first data is “8.”

For the feature amounts of the second data, the evaluation data feature amounts include the number of users to whom the coupon A is provided “3,000,” the number of users to whom the coupon is provided “8,000,” the segment “age>20,” the data collection month “November,” and the sample size “15,000.” Additionally, the true data feature amounts include the number of users to whom the coupon A is provided “2,000,” the number of users to whom the coupon is provided “10,000,” the segment “age>20,” the data collection month “November,” and the sample size “15,000,” and the offline evaluated values for IPW, DM, and DR are “7, 9, 8.” The true KPI for the second data is “6.”

For the feature amounts of the third data, the evaluation data feature amounts include the number of users to whom the coupon A is provided “5,000,” the number of users to whom the coupon is provided “12,000,” the segment “age>20,” the data collection month “November,” and the sample size “30,000.” Additionally, the true data feature amounts include the number of users to whom the coupon A is provided “3,000,” the number of users to whom the coupon is provided “8,000,” the segment “age>20,” the data collection month “November,” and the sample size “15,000,” and the offline evaluated values for IPW, DM, and DR are “10, 7, 9.” The true KPI for the first data is “8.”

For the feature amounts of the fourth data, the evaluation data feature amounts include the number of users to whom the coupon A is provided “6,000,” the number of users to whom the coupon is provided “16,000,” the segment “age>20,” the data collection month “September,” and the sample size “30,000.” Additionally, the true data feature amounts include the number of users to whom the coupon A is provided “2,000,” the number of users to whom the coupon is provided “10,000,” the segment “age>20,” the data collection month “November,” and the sample size “15,000,” and the offline evaluated values for IPW, DM, and DR are “6, 8, 7.” The true KPI for the second data is “6.”

Additionally, in the examples described above, the offline evaluation methods used include IPW, DM, and DR. However, any offline evaluation method other than IPW, DM, and DR may be used. For example, More Robust Doubly Robust can be used.

### <3. Use Cases>

Now, as a use case, provision of a coupon at an EC (Electronic Commerce) site will be described with reference to the flowchart in FIG. 2 again.

In step S11, in response to operation of the operator-side staff member, the KPI input section 21 receives “sales” as the KPI to be optimized by intervention, and outputs “sales” to the model training section 24.

In step S12, in response to operation of the operator-side staff member, the segment input section 22 receives “long-term user” as a user segment to be optimized by intervention, and outputs “sales” to the model training section 24.

In step S13, in response to operation of the operator-side staff member, the baseline input section 23 receives a baseline as an input and outputs the baseline to the model training section 24. For example, a possible baseline in the related art is an intervention allocation manually designed by a marketer, or the like. In the present use case, the input baseline is “provision of a 10% OFF coupon is input for users with a cumulative purchase amount of 100,000 yen and a 30% OFF coupon is provided to users with a cumulative purchase amount of less than 100,000 yen.”

In step S14, the model training section 24 trains the model using the user log saved in the user log saving section 39 and the intervention information saved in the intervention saving section 31. The model learns the optimum intervention for the group of users included in the user segment fed from the segment input section 22 in such a manner as to maximize the KPI fed from the KPI input section 21. As a learning result from the model, a new intervention allocation provided by the model is output.

That is, in this case, the user log saving section 39 includes the past purchase histories of the users saved therein. Additionally, the intervention saving section 31 includes the intervention methods saved therein, which were implemented in the past using coupons. For example, the intervention saving section 31 includes intervention methods saved therein, which use “a 10% OFF coupon, a 30% OFF coupon, and a 50% OFF coupon.”

The model training section 24 uses these pieces of information to learn the optimum coupon on a per-user basis in such a manner as to maximize the “sales,” which is a KPI input in advance. For example, a learning result is assumed to be obtained that indicates that “a 10% OFF coupon is provided to users with a cumulative purchase amount of 200,000 yen or more, a 30% OFF coupon is provided to users with a cumulative purchase amount of 50,000 yen or more and less than 200,000 yen, and a 50% OFF coupon is provided to users with a cumulative purchase amount of less than 50,000 yen.” The trained model is saved in the model saving section 25.

The model training section 24 outputs, to the model offline evaluating section 26, the learned model and the data used to train the model.

In step S15, the model offline evaluating section 26 performs offline evaluation on the model fed by the model training section 24.

That is, the model offline evaluating section 26 calculates a predicted value for expected sales provided by the offline evaluation model using, as inputs, feature amounts such as data used for the offline evaluation, information regarding the plan for the actual coupon provision, and predicted values for expected sales for the model and baseline intervention allocations provided by OPE.

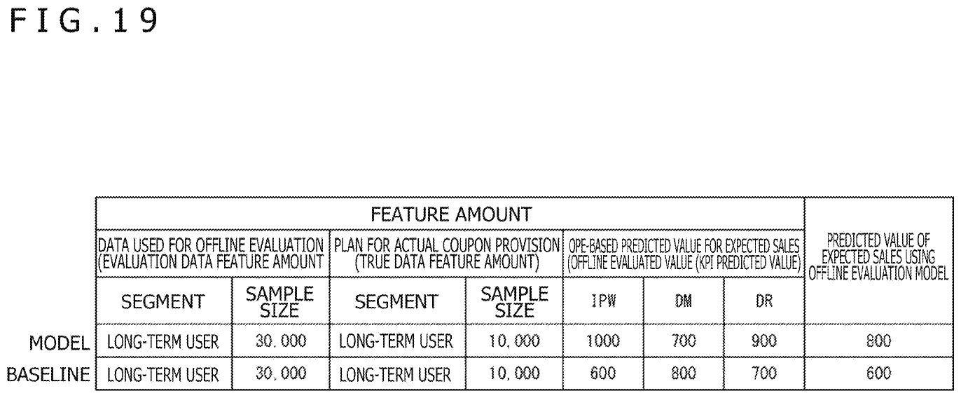

FIG. 19 is a diagram illustrating an example of offline evaluation performed by the model offline evaluating section 26.

The feature amounts used as inputs include data used for the offline evaluation, the plan for the actual coupon provision, and the predicted values for expected sales provided by OPE. The data used for the offline evaluation and the plan for the actual coupon provision each include the segment and the sample size. The predicted values for the expected sales provided by OPE include IPW, DW, and DP.

For the model intervention allocation, as the feature amounts used as inputs, the data used for the offline evaluation model includes the segment “long-term user,” and the sample size “30,000,” and the information regarding the plan for the actual coupon provision includes the segment “long-term user” and the sample size “10,000,” and the predicted values for the expected sales provided by OPE include the IPW “1000,” the DM “700,” and the DR “900.”

For the model intervention allocation, the predicted value for the expected sales provided by the offline evaluation model is “800.”

For the baseline intervention allocation, as the feature amounts used as inputs, the data used for the offline evaluation model includes the segment “long-term user” and the sample size “30,000,” the information regarding the plan for the actual coupon provision includes the segment “long-term user” and the sample size “10,000,” and the predicted values for the expected sales provided by OPE include the IPW “600,” the DM “800,” and the DR “700.”

For the baseline intervention allocation, the predicted value for the expected sales provided by the offline evaluation model is “600.”

Note that, as depicted in FIG. 19, the data used for the offline evaluation is saved as an evaluation data feature amount and used for training of the offline evaluation model and the like. The information regarding the plan for the actual coupon provision is saved as true data feature amount and used for training of the offline evaluation model and the like. The predicted value for the expected sales provided by the offline evaluation model is saved as an offline evaluation value and used for training of the offline evaluation model and the like. The offline evaluation model has been trained in the last step S28.

The data used for the offline evaluation, the predicted value for the expected sales provided by the offline evaluation model, and the like in FIG. 19 are output to the model offline evaluation result saving section 27. The calculated offline evaluated value is output to the new intervention target estimating section 28.

In step S16, the new intervention target estimating section 28 estimates whether there is any user for whom the existing intervention is not expected to be effective on the basis of the offline evaluated value fed from the model offline evaluating section 26.

In step S17, the new intervention target estimating section 28 determines whether or not there is any user for whom the existing intervention is not expected to be effective on the basis of an estimation result in step S16.

For example, the intervention for providing the “10% OFF coupon, 30% OFF coupon, and 50% OFF coupon” is not expected to be effective for “users with a cumulative purchase amount of 200,000 yen.” In this case, step S17 determines that there is a user for whom the existing intervention is not expected to be effective, and the processing proceeds to step S18.

In step S18, the new intervention target presenting section 29 indicates that there is a user for whom the existing intervention is not expected to be effective, and encourages the operator-side staff member to add a new intervention targeted for the user.

In step S19, in response to operation of the operator-side staff member, the new intervention input section 30 receives information regarding a new intervention as an input and outputs the received information regarding the intervention to the intervention saving section 31 and the intervention design generating section 34. The intervention saving section 31 saves the information regarding the intervention fed from the new intervention input section 30.

In a case where step S17 determines that there is no user for whom the existing intervention is not expected to be effective, the processing in steps S18 and S19 is skipped, and the processing proceeds to step S20.

In step S20, the intervention randomization rate estimating section 32 estimates the optimum rate of random intervention with users including random allocation of the coupons. In FIG. 19, the offline evaluation provides offline evaluated values indicating that the expected sales are 800 yen for the model and 600 yen for the baseline, and the plan for the actual coupon provision includes provision of each coupon to 10,000 users.

Here, the intervention randomization rate estimating section 32 calculates a sample size required to detect a statistically significant difference in sales between the model and the baseline. For example, in a case where the calculation results indicate that the “model is applied to 8,000 users, and the baseline is applied to 8,000 users,” the coupons are randomly provided to the remaining 2,000 users for each of the model and the baseline.

In step S21, the intervention allocation description generating section 33 generates an intervention allocation description including comparison information between the baseline and the model for coupon provision and expected sales.

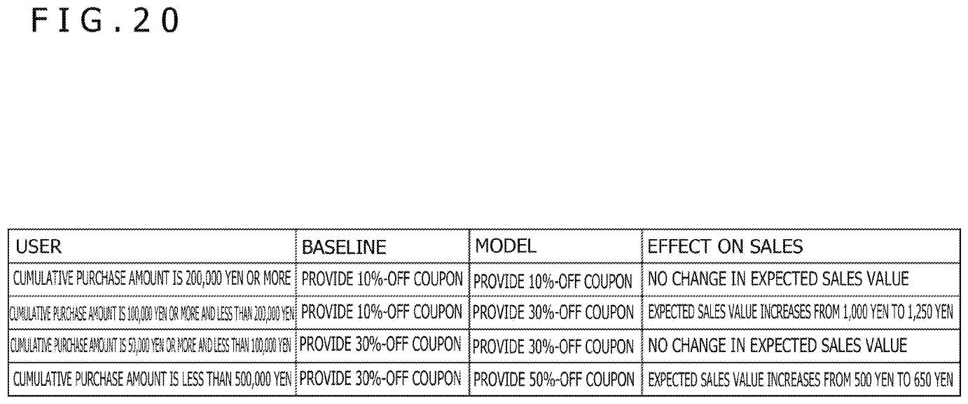

FIG. 20 is a diagram illustrating an example of intervention allocation description generated by the intervention allocation description generating section 33.

In FIG. 20, “user” indicates the user feature amounts, “baseline” indicates the baseline intervention allocation, “model” indicates the model intervention allocation, and “effect on sales” indicates what level of effect on the sales is expected in a case where the baseline intervention allocation is changed to the model intervention allocation.

In the first intervention allocation description, “user” is represented as “cumulative purchase amount is 200,000 yen or more,” “baseline” is represented as “provide 10% OFF coupon,” “model” is represented as “provide 10% OFF coupon,” and “effect on sales” is represented as “no change in expected sales value.”

In the second intervention allocation description, “user” is represented as “cumulative purchase amount is 100,000 yen or more and less than 200,000 yen,” “baseline” is represented as “provide 10% OFF coupon,” “model” is represented as “provide 30% OFF coupon,” and “effect on sales” is represented as “expected sales value increases from 1,000 yen to 1,250 yen.”

In the third intervention allocation description, “user” is represented as “cumulative purchase amount is 50,000 yen or more and less than 100,000 yen,” “baseline” is represented as “provide 30% OFF coupon,” “model” is represented as “provide 30% OFF coupon,” and “effect on sales” is represented as “no change in expected sales value.”

In the fourth intervention allocation description, “user” is represented as “cumulative purchase amount is less than 500,000 yen,” “baseline” is represented as “provide 30% OFF coupon,” “model” is represented as “provide 50% OFF coupon,” and “effect on sales” is represented as “expected sales value increases from 500 yen to 650 yen.”

In step S22, the intervention design generating section 34 generates final design information regarding coupon provision on the basis of the data used for the offline evaluation, the rate of random intervention with users, and the intervention allocation description.

The intervention design generating section 34 also outputs the generated design information regarding the coupon provision to the intervention design saving section 35 and the intervention section 37. The intervention design generating section 34 outputs the generated design information regarding the coupon provision to the intervention design checking section 36.

In step S23, to have the operator-side staff member check the intervention design information before the actual intervention is performed, the intervention design checking section 36 presents the intervention design information fed from the intervention design generating section 34.

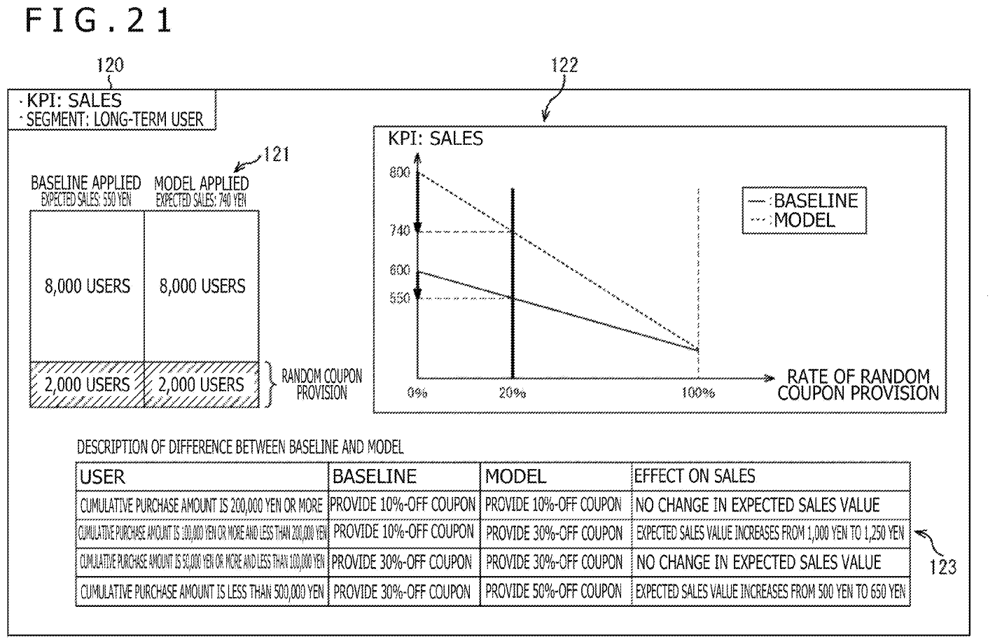

FIG. 21 is a diagram illustrating an example of a UI presented by the intervention design checking section 36.

FIG. 21 depicts a UI 120 for final check of coupon provision design with the KPI “sales” and the segment “long-term user” as depicted in the upper left of the diagram. Note that FIG. 21 depicts predicted values for expected sales as sales.

The UI 120 includes a randomization rate presenting section 121 that presents a randomization rate, a randomization rate adjusting section 122 that can adjust the randomization rate, and a description presenting section 123 that presents the intervention allocation description in FIG. 20.

The randomization rate presenting section 121 indicates that, in each of the case of application of the baseline with expected sales of 550 yen and the case of application of the model with expected sales of 740 yen, the result of calculation of the sample size required to make a significant difference is 8,000 users of 10,000 users. Additionally, the randomization rate presenting section 121 indicates that random coupon provision is performed on the remaining 2,000 users.

The randomization rate adjusting section 122 presents a UI that can adjust the rate of random intervention as is the case with FIG. 16.

The horizontal axis indicates the rate of random coupon provision. The vertical axis indicates the sales corresponding to the rate of random coupon provision. A solid graph represents baseline sales, whereas a graph of an alternate long and short dash line represents model sales.

The randomization rate adjusting section 122 displays an example in which an adjustment bar for the rate of random coupon provision is positioned at 20%. In this case, the vertical axis indicates the risk that the KPI obtained in a case where the rate of random coupon provision is 20% decreases by 50 for the baseline and by 60 for the model compared to the KPI obtained in a case where the rate of random coupon provision is 0%.

For example, when the intervention design checking section 36 presents the UI configured as described above, the operator-side staff member can check the coupon provision design information.

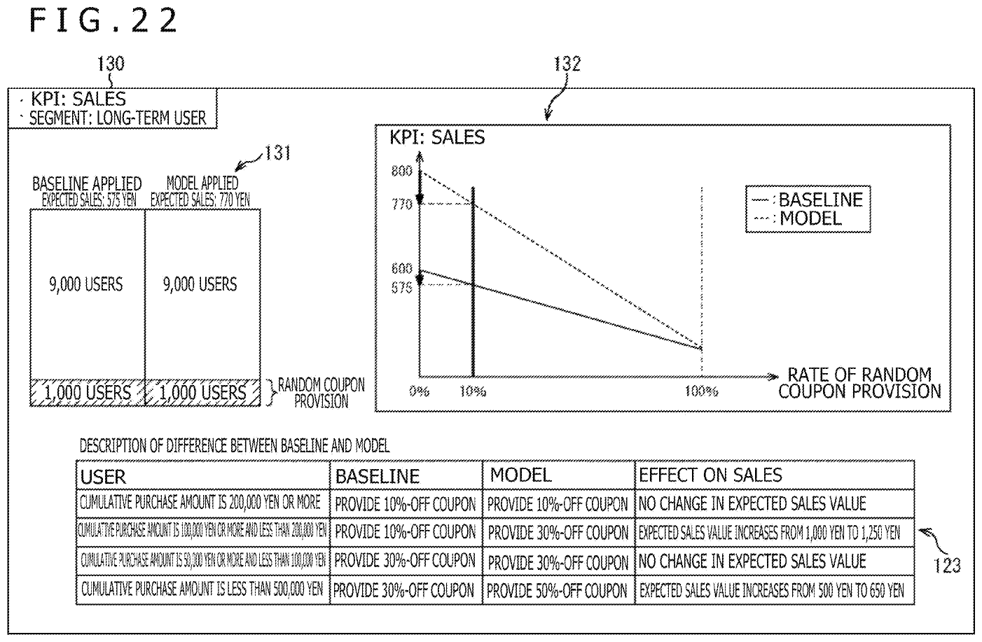

FIG. 22 is a diagram illustrating an example of a UI with the rate of random coupon provision adjusted.

FIG. 22 illustrates an example of a UI in which the operator-side staff member has adjusted the rate of random coupon provision, which was 20%, to 10%.

The randomization rate presenting section 121 in FIG. 22 indicates 9,000 users as the calculation result of the comparison of the sample size, which is 8,000 users in the randomization rate presenting section 121 in FIG. 21, and indicates 1,000 users as the number of the remaining users, which is 2,000 users in the randomization rate presenting section 121 in FIG. 21.

The randomization rate adjusting section 122 in FIG. 22 displays an example in which the adjustment bar for the rate of random coupon provision, the rate of random coupon provision has shifted from 20% to 10%. The risk indicated by the vertical axis in FIG. 22 differs from the risk in the example in FIG. 21; the sales obtained in a case where the rate of random coupon provision is 10% decreases by 25 for the baseline and by 30 for the model compared to the sales obtained in a case where the rate of random coupon provision is 0%.

In the UI configured as described above, when the operator-side staff member slides the adjustment bar in the randomization rate adjusting section 122, the expected sales value is displayed in conjunction with sliding of the adjustment bar. Thus, the operator-side staff member can generate coupon provision design information while adjusting the allowable risk.

In step S24, on the basis of the coupon provision design information generated by the intervention design generating section 34, the coupons are provided to the users, that is, coupon provision is performed on the display section of the user terminal.

In step S25, the user state acquiring section 38 acquires, from the UI of the user terminal or the sensor, information (purchase history of the user) indicating behavior taken by the user as a result of the intervention, and outputs the acquired information to the user log saving section 39.

In step S26, the intervention result analyzing section 40 references the purchase histories of the users in the user log saving section 39, compares the model with the baseline, and analyzes the intervention results to check whether or not the actual sales (measured values) have improved. The intervention result analyzing section 40 outputs the comparison result of the comparison between the model and the baseline to the intervention result checking section 41 and the intervention result saving section 42.

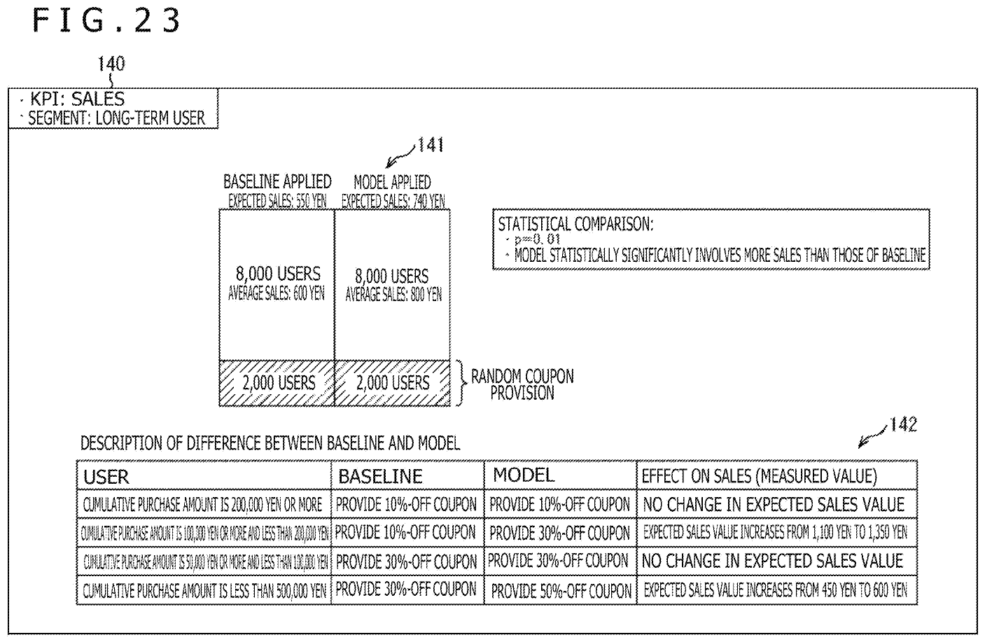

In step S27, to have the operator-side staff member check the result of the coupon provision, the intervention result checking section 41 presents the comparison result of the comparison between the model and the baseline analyzed by the intervention result analyzing section 40, as depicted in FIG. 23.

FIG. 23 is a diagram illustrating an example of a UI presented by the intervention result checking section 41.

FIG. 23 depicts a UI 140 for final check of the coupon provision design for the KPI “sales” and the segment “long-term user” as depicted in the upper left of the diagram. Note that FIG. 23 depicts measured sales values as sales.

The UI 140 includes an analysis result presenting section 141 that presents the result of analysis of the coupon provision, and a description presenting section 142 that presents description of the difference (comparison information) between the model and the baseline.

The analysis result presenting section 141 indicates that, in each of the case of application of the baseline with average sales of 550 yen and the case of application of the model, the result of calculation of the sample size required to make a significant difference is 8,000 users of 10,000 users and that, for the 8,000 users, the average sales are 600 yen.

Additionally, the analysis result presenting section 141 indicates that, in each of the case of application of the model with average sales of 740 yen and the case of application of the baseline, the result of calculation of the sample size required to make a significant difference is 8,000 users of 10,000 users and that, for the 8,000 users, the average sales are 800 yen. Additionally, the analysis result presenting section 141 indicates that, for both cases of application, the coupons are randomly provided to the remaining 2,000 users.

The analysis result presenting section 141 indicates, on the right side of the diagram, that, as statistical comparison, “p=0.01 and the model statistically significantly involves more sales than those of the baseline.”

Unlike the case in FIG. 16, the description presenting section 142 presents intervention allocation descriptions of the effect of sales difference between the base line and the model in measured sales value.

That is, in the first intervention allocation description, “user” is represented as “cumulative purchase amount is 200,000 yen or more,” “baseline” is represented as “provide 10% OFF coupon,” “model” is represented as “provide 10% OFF coupon,” and “effect on sales” is represented as “no change in expected sales value (measured value).”

That is, in the second intervention allocation description, “user” is represented as “cumulative purchase amount is 100,000 yen or more and less than 200,000 yen,” “baseline” is represented as “provide 10% OFF coupon,” “model” is represented as “provide 30% OFF coupon,” and “effect on sales” is represented as “expected sales value (measured value) increases from 1,100 yen to 1,350 yen.”

The third intervention allocation description, “user” is represented as “cumulative purchase amount is 50,000 yen or more and less than 100,000,” “baseline” is represented as “provide 30% OFF coupon,” “model” is represented as “provide 30% OFF coupon,” and “effect on sales” is represented as “no change in expected sales value (measured value).”

The fourth intervention allocation description, “user” is represented as “cumulative purchase amount is less than 500,000 yen,” “baseline” is represented as “provide 30% OFF coupon,” “model” is represented as “provide 50% OFF coupon,” and “effect on sales” is represented as “expected sales value (actual value) increases from 450 yen to 600 yen.”

In step S28, the evaluation section 43 for the offline evaluation method and the training section 45 for the offline evaluation model train the offline evaluation model.

First, actual intervention results fed from the intervention result analyzing section 40 are output to the evaluation section 43 for the offline evaluation method and the evaluation result saving section 44 for the offline evaluation method.

However, the evaluation result saving section 44 for the offline evaluation method is fed with the actual intervention results fed from the intervention result analyzing section 40 and coupled to the data used for the offline evaluation, the offline evaluated value provided by each OPE, and the like, which are saved in the model offline evaluation result saving section 27.

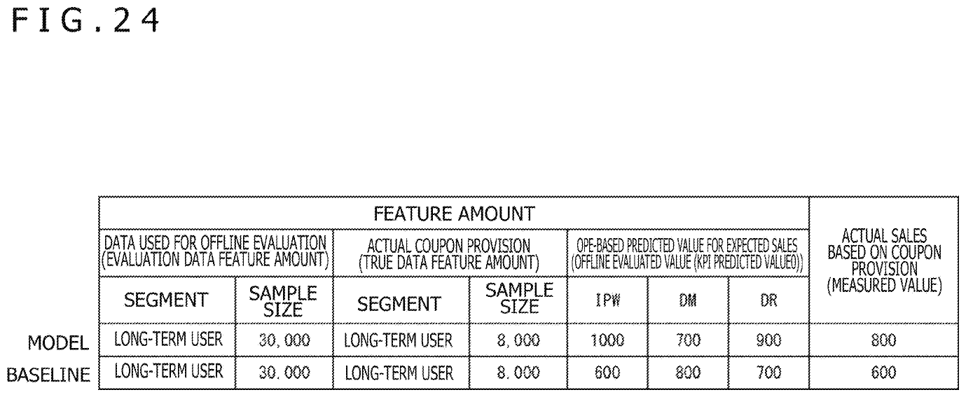

FIG. 24 is a diagram illustrating an example of data obtained by coupling the data saved in the model offline evaluation result saving section 27 to the results of the actual coupon provision.

FIG. 24 differs from FIG. 19 in the information regarding the plan for the actual coupon provision; the sample size for the segment “long-term user” is changed from “10,000” to “8,000,” and the predicted value for the expected sales provided by the offline evaluation model is changed to the sales (measured value) obtained by the actual coupon provision.

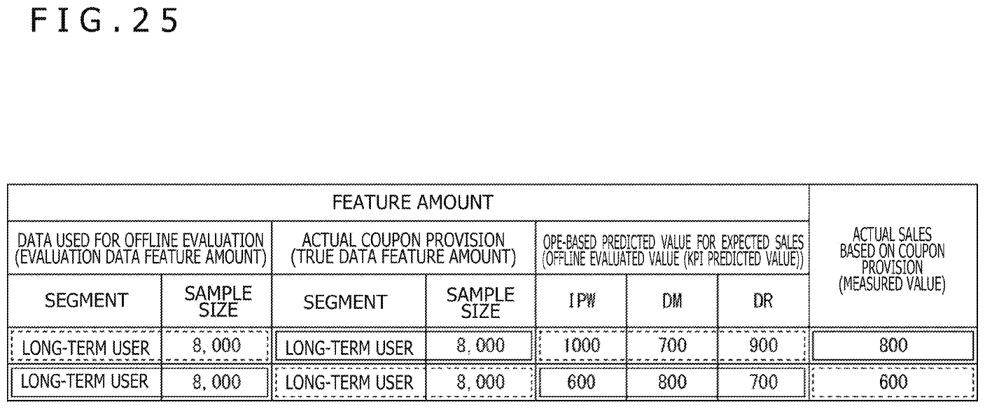

Additionally, the evaluation section 43 for the offline evaluation model evaluates the sales prediction by OPE using each of the data regarding the users to whom the model is applied and the data regarding the users to whom the baseline is applied as depicted in, for example, FIG. 25.

FIG. 25 is a diagram illustrating an example of data obtained by evaluation of the offline evaluation method using the intervention results.

FIG. 25 depicts, as data feature amounts, data including the evaluation data feature amount, the true data feature amount, and the online evaluated value, and also depicts the sales obtained by the actual coupon provision. Additionally, among the data and the sales obtained by the actual coupon provision in FIG. 25, the data depicted by dash lines is data regarding the users to whom the baseline is applied. Additionally, the data depicted by solid lines is data regarding the users to whom the model is applied.

Consequently, the feature amounts of the first data include the segment for the evaluation data feature amount to which the baseline is applied “long-term user” and the sample size “30,000,” and the segment for the true data feature amount to which the model is applied “long-term user” and the sample size “30,000.” The offline evaluated values for IPW, DM, and DR employing the baseline are “1000, 700, 900,” respectively. The sales obtained by the actual coupon provision employing the model is “800.”

That is, in the first data, the data to which the baseline is applied is used for the evaluation data feature amounts and each offline evaluated value, and the data to which the model is applied is used for the true data feature amounts and the sales obtained by the actual coupon provision.

the feature amounts of the second data include the segment for the evaluation data feature amount to which the model is applied “long-term user” and the sample size “30,000,” and the segment for the true data feature amount to which the baseline is applied “long-term user” and the sample size “30,000.” The offline evaluated values for IPW, DM, and DR employing the model are “600, 800, 700,” respectively. The sales obtained by the actual coupon provision employing the baseline is “600.”

That is, in the second data, the data to which the model is applied is used for the evaluation data feature amounts and each offline evaluated value, and the data to which the baseline is applied is used for the true data feature amounts and the sales obtained by the actual coupon provision.

As described above, the evaluation section 43 for the offline evaluation method evaluates the sales prediction by OPE using each of the data regarding the users to whom the model is applied and the data regarding the users to whom the baseline is applied. The evaluation section 43 for the offline evaluation method outputs the data in FIG. 25 to the evaluation result saving section 44 for the offline evaluation method.

The evaluation result saving section 44 for the offline evaluation method saves the data in FIG. 24 and the data in FIG. 25 fed from the evaluation section 43 for the offline evaluation method.

The training section 45 for the offline evaluation model trains the offline evaluation model using the data (FIG. 24 and FIG. 25) saved in the evaluation result saving section 44 for the offline evaluation method.

The offline evaluation model trained herein is used during the next offline evaluation performed by the model offline evaluating section 26. Repetition of training and evaluation as described above increases the amount of data saved in the evaluation result saving section 44 for the offline evaluation method, improving the accuracy of the of offline evaluation model.

### <4. Others>

### <Effects of Known Art and Present Technology>

As described above, marketers primarily have planned measures for coupon provision and the like at EC sites. However, a recently developed data utilization technology has allowed per-user optimum measures to be estimated using a learning model.

The learning model generally tends to be a black box. Additionally, an existing description of a model includes outputting only a description of the simple model corresponding to a description of what the model is like. For example, a technology allowing contributing feature amounts to be indicated has been proposed.

However, a person responsible for the measures needs to describe “how a new intervention allocation provided by the model differs from the existing intervention allocation and, as a result, what level of effect is expected from the intervention allocation provided by the model” instead of the description of the simple model.

In the present technology, a intervention allocation description is generated that includes comparison information between a first intervention allocation indicating the correspondence relation between a user feature amount and an intervention and a second intervention allocation indicating the correspondence relation between the user feature amount and the intervention and newly provided using the learning model, and comparison information for an expected evaluated value between a case where the intervention is performed on the basis of the first intervention allocation and a case where the intervention is performed on the basis of the second intervention allocation.

Consequently, the learning model can be prevented from being a black box. This allows construction of a system suitable for validation of effects of causal inference.

Additionally, causal inference is generally based on the assumption that the intervention is probabilistic.

However, an intervention allocation provided by a known learning model and an intervention allocation manually designed by a marketer are generally deterministic. Consequently, in the existing system, accumulated data is often not suitable for causal inference, and, for optimization based on causal inference, data needs to be collected whenever the need for the optimization arises.

According to the present technology determines the intervention randomization rate at which interventions are randomly allocated to the users.

Consequently, data subjected to probabilistic intervention allocations can be collected. This allows construction of a system suitable for validation of effects of causal inference.

Furthermore, the offline evaluation of a model based on causal inference is referred to as OPE and includes a large number of methods. The OPE allows an expected KPI value to be estimated that is obtained in a case where the intervention is performed in accordance with a certain intervention allocation. However, which of the OPE methods is an offline evaluation method with a high estimation accuracy depends on the neck type and amount of data. Consequently, in a case where the offline evaluation is to be performed, the OPE method needs to be determined.

Thus, many methods for selecting an OPE method have been proposed but have the following disadvantages.

With any selection technology, selection of one of the OPE methods completely discards the offline evaluation based on the other OPE method and thus has the same meaning as discarding of a portion of the information.

Additionally, none of the selection technologies take into account the difference between validation with local data used for the offline evaluation and online validation. For example, in fact, offline validation of effects may be subject to seasonality and an increase or a decrease in sample size. Thus, offline evaluation using the other OPE method may have been more robust than offline evaluation using the selected OPE method.

In the present technology, offline evaluation of a leaning model is performed using an offline evaluation model for using, as inputs, data feature amounts and expected evaluated values provided by a plurality of offline evaluation methods for the first intervention allocation and the second intervention allocation to predict an actual evaluated value for the result of the intervention performed on the basis of the intervention allocation to be evaluated.

Consequently, the accuracy of the evaluation can be improved without discarding any of the plurality of offline evaluation methods. This allows construction of a system suitable for validation of effects of causal inference.

Additionally, in the present technology, the offline evaluation model is trained on the basis of a first feature amount corresponding to a feature amount of data to be evaluated, the actual evaluated value for a result of the intervention performed on the basis of the intervention allocation to be evaluated using the first feature amount, a second feature amount corresponding to a feature amount of evaluation data, and the expected evaluated value provided by the offline evaluation method based on the intervention allocation using the second feature amount.

Consequently, repetition of cycles of effect validation enables an increase in the accuracy of the offline evaluation. This allows construction of a system suitable for validation of effects of causal inference.

### <Configuration Example of Computer>

The above-described series of processing can be executed by hardware or by software. In a case where the series of processing is executed by software, a program constituting the software is installed from a program recoding medium into a computer integrated in dedicated hardware, a general-purpose personal computer, or the like.

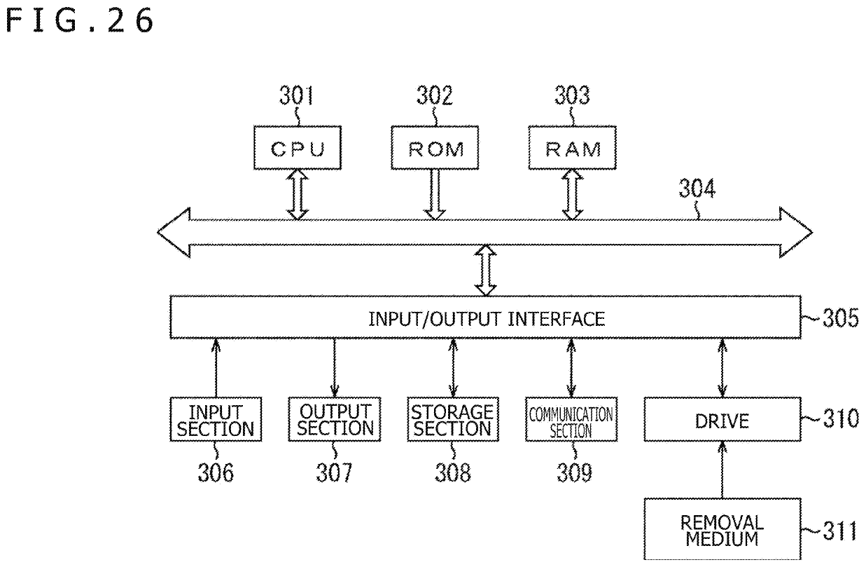

FIG. 26 is a block diagram illustrating a configuration example of hardware of a computer executing the above-described series of processing using a program.

A CPU 301, a ROM (Read Only Memory) 302, and a RAM 303 are connected together by a bus 304.

The bus 304 further connects an input/output interface 305. The input/output interface 305 connects to an input section 306 including a keyboard, a mouse, and the like, and an output section 307 including a display, a speaker, and the like. Additionally, the input/output interface 305 connects to a storage section 308 including a hard disk, a nonvolatile memory, and the like, a communication section 309 including a network interface and the like, and a drive 310 that drives a removable medium 311.

In the computer configured as described above, the above-described series of processing is executed by the CPU 301, for example, loading programs stored in the storage section 308 into the RAM 303 via the input/output interface 305 and the bus 304 and executing the programs.

The programs executed by the CPU 301 are, for example, recorded in the removable medium 311 or provided via a wired or wireless transmission medium such as a local area network, the Internet, or digital broadcasting, and are installed in the storage section 308.

Note that the programs executed by the computer may chronologically execute processing along the order described herein or execute processing in parallel or at required timings such as when the programs are invoked.

Note that the system as used herein means a set of a plurality of components (apparatuses, modules (parts), or the like) regardless of whether or not all the components are in the same housing. Consequently, the system corresponds to either a plurality of apparatuses housed in separate housings and connected together via a network or one apparatus including a plurality of modules housed in one housing.

Additionally, the effects described herein are only illustrative and not restrictive, and any other effect may be produced.

The embodiment of the present technology are not limited to the above-described embodiment, and many variations may be made to the embodiment without departing from the spirits of the present technology.

For example, the present technology can take a cloud computing configuration in which one function is shared and jointly processed by a plurality of apparatuses via a network.

Additionally, the steps described above in the flowcharts can be executed by one apparatus or can be shared and executed by a plurality of apparatuses.

Furthermore, in a case where one step includes a plurality of processing operations, the plurality of processing operations included in the one step can be executed by one apparatus or can be shared and executed by a plurality of apparatuses.

### <Combination Example of Configurations>

The present technology can also adopt the following configurations.

(1)

An information processing apparatus including:
a description generating section generating an intervention allocation description including comparison information between a first intervention allocation indicating a correspondence relation between a user feature amount and an intervention and a second intervention allocation indicating a correspondence relation between the user feature amount and the intervention and newly provided using a learning model, and comparison information for an expected evaluated value between a case where the intervention is performed on the basis of the first intervention allocation and a case where the intervention is performed on the basis of the second intervention allocation.

(2)

The information processing apparatus according to (1) above, further including:
a model offline evaluating section performing offline evaluation of the learning model using an offline evaluation model using, as inputs, data feature amounts and the expected evaluated values provided by a plurality of offline evaluation methods for the first intervention allocation and the second intervention allocation to predict an actual evaluated value for a result of the intervention performed on the basis of an intervention allocation to be evaluated.

(3)

The information processing apparatus according to (2) above, in which the offline evaluation method includes at least two of Inverse Probability Weighting (IPW), Direct Method (DM), Doubly Robust (DR), and More Robust Doubly Robust.

(4)

The information processing apparatus according to (3) above, further including:
an offline evaluation model training section training the offline evaluation model on the basis of a first data feature amount corresponding to the data feature amount to be evaluated, the actual evaluated value for a result of the intervention performed on the basis of the intervention allocation to be evaluated using the first data feature amount, a second data feature amount corresponding to a data feature amount for evaluation, and the expected evaluated value provided by the offline evaluation method based on the intervention allocation using the second data feature amount.

(5)

The information processing apparatus according to (4) above, in which the offline evaluation model training section uses the first data feature amount, the second data feature amount, and the expected evaluated value as inputs to train the offline evaluation model using an objective variable as the actual evaluated value.

(6)

The information processing apparatus according to (5) above, in which the first data feature amount and the second data feature amount include at least one of a user segment to be optimized, a data collection period, and a sample size.

(7)

The information processing apparatus according to (5) above, in which the first data feature amount and the second data feature amount include the number of users on whom the intervention is performed or a ratio to a total number of the users on whom the intervention is performed.

(8)

The information processing apparatus according to any one of (2) to (7) above, further including:
an intervention randomization rate estimating section determining an intervention randomization rate corresponding to a rate at which the intervention is randomly allocated to users.

(9)

The information processing apparatus according to (8) above, in which the intervention randomization rate estimating section calculates a sample size expected to make a significant difference in the expected evaluated value provided by a plurality of the offline evaluation methods for each of the first intervention allocation and the second intervention allocation, and determines a rate of random intervention with the users on the basis of the calculated sample size.

(10)

The information processing apparatus according to (8) above, in which the intervention randomization rate estimating section determines a rate of random intervention with the users in association with operation of a user responsible for intervention design.

(11)

The information processing apparatus according to (8) above, further including:
an intervention design generating section generating design information regarding the intervention on the basis of the intervention allocation description and a rate of random intervention with the users.

(12)

The information processing apparatus according to any one of (2) to (11) above, further including:
a new intervention target estimating section extracting the user feature amount for which the first intervention allocation is not expected to increase the expected evaluated value, on the basis of an evaluation result of the offline evaluation.

(13)

The information processing apparatus according to (12) above, further including:
a new intervention target presenting section controlling presentation of the user feature amount extracted by the new intervention target estimating section.

(14)

The information processing apparatus according to any one of (2) to (13) above, in which the description generating section uses, as inputs, the user feature amounts and the expected evaluated values provided by a plurality of the offline evaluation methods for the first intervention allocation and the second intervention allocation associated with each segment of the user feature amount, to generate the intervention allocation description using the offline evaluation model.

(15)

The information processing apparatus according to (1) above, in which the description generating section generates the intervention allocation description including comparison information between the first intervention allocation and the second intervention allocation and comparison information between a first actual evaluated value for a result of the intervention performed on the basis of the first intervention allocation and a second actual evaluated value for a result of the intervention performed on the basis of the second intervention allocation.

(16)

The information processing apparatus according to any one of (1) to (15) above, in which the description generating section generates the intervention allocation description for each of the users.

(17)

The information processing apparatus according to any one of (1) to (16) above, further including:
a presentation control section controlling presentation of the intervention allocation description.

(18)

The information processing apparatus according to any one of (1) to (17) above, further including:
a model training section using a user log and the existing intervention, as an input, to train the learning model generating the second intervention allocation.

(19)

An information processing method including:
generating, by an information processing apparatus, an intervention allocation description including comparison information between a first intervention allocation indicating a correspondence relation between a user feature amount and an intervention and a second intervention allocation indicating a correspondence relation between the user feature amount and the intervention and newly provided using a learning model, and comparison information for an expected evaluated value between a case where the intervention is performed on the basis of the first intervention allocation and a case where the intervention is performed on the basis of the second intervention allocation.

(20)

A program causing a computer to function as:
a description generating section generating an intervention allocation description including comparison information between a first intervention allocation indicating a correspondence relation between a user feature amount and an intervention and a second intervention allocation indicating a correspondence relation between the user feature amount and the intervention and newly provided using a learning model, and comparison information for an expected evaluated value between a case where the intervention is performed on the basis of the first intervention allocation and a case where the intervention is performed on the basis of the second intervention allocation.

### REFERENCE SIGNS LIST

11: Intervention processing system
21: KPI input section
22: Segment input section
23: Baseline input section
24: Model training section
25: Model saving section
26: Model offline evaluating section
27: Model offline evaluation result saving section
28: New intervention target estimating section
29: New intervention target presenting section
30: New intervention input section
31: Intervention saving section
32: Intervention randomization rate estimating section
33: Intervention allocation description generating section
34: Intervention design generating section
35: Intervention design saving section
36: Intervention design checking section
37: Intervention section
38: User state acquiring section
39: User log saving section
40: Intervention result analyzing section
41: Intervention result checking section
42: Intervention result saving section
43: Evaluation section for offline evaluation method
44: Evaluation result saving section for offline evaluation method
45: Evaluation section for offline evaluation model

1. An information processing apparatus comprising:
a description generating section generating an intervention allocation description including comparison information between a first intervention allocation indicating a correspondence relation between a user feature amount and an intervention and a second intervention allocation indicating a correspondence relation between the user feature amount and the intervention and newly provided using a learning model, and comparison information for an expected evaluated value between a case where the intervention is performed on a basis of the first intervention allocation and a case where the intervention is performed on a basis of the second intervention allocation.

2. The information processing apparatus according to claim 1, further comprising:
a model offline evaluating section performing offline evaluation of the learning model using an offline evaluation model using, as inputs, data feature amounts and the expected evaluated values provided by a plurality of offline evaluation methods for the first intervention allocation and the second intervention allocation to predict an actual evaluated value for a result of the intervention performed on a basis of an intervention allocation to be evaluated.

3. The information processing apparatus according to claim 2, wherein the offline evaluation method includes at least two of Inverse Probability Weighting (IPW), Direct Method (DM), Doubly Robust (DR), and More Robust Doubly Robust.

4. The information processing apparatus according to claim 2, further comprising:
an offline evaluation model training section training the offline evaluation model on a basis of a first data feature amount corresponding to the data feature amount to be evaluated, the actual evaluated value for a result of the intervention performed on the basis of the intervention allocation to be evaluated using the first data feature amount, a second data feature amount corresponding to a data feature amount for evaluation, and the expected evaluated value provided by the offline evaluation method based on the intervention allocation using the second data feature amount.

5. The information processing apparatus according to claim 4, wherein the offline evaluation model training section uses the first data feature amount, the second data feature amount, and the expected evaluated value as inputs to train the offline evaluation model using an objective variable as the actual evaluated value.

6. The information processing apparatus according to claim 5, wherein the first data feature amount and the second data feature amount include at least one of a user segment to be optimized, a data collection period, and a sample size.

7. The information processing apparatus according to claim 5, wherein the first data feature amount and the second data feature amount include the number of users on whom the intervention is performed or a ratio to a total number of the users on whom the intervention is performed.

8. The information processing apparatus according to claim 2, further comprising:
an intervention randomization rate estimating section determining an intervention randomization rate corresponding to a rate at which the intervention is randomly allocated to users.

9. The information processing apparatus according to claim 8, wherein the intervention randomization rate estimating section calculates a sample size expected to make a significant difference in the expected evaluated value provided by a plurality of the offline evaluation methods for each of the first intervention allocation and the second intervention allocation, and determines a rate of random intervention with the users on a basis of the calculated sample size.

10. The information processing apparatus according to claim 8, wherein the intervention randomization rate estimating section determines a rate of random intervention with the users in association with operation of a user responsible for intervention design.

11. The information processing apparatus according to claim 8, further comprising:
an intervention design generating section generating design information regarding the intervention on a basis of the intervention allocation description and a rate of random intervention with the users.

12. The information processing apparatus according to claim 2, further comprising:
a new intervention target estimating section extracting the user feature amount for which the first intervention allocation is not expected to increase the expected evaluated value, on a basis of an evaluation result of the offline evaluation.

13. The information processing apparatus according to claim 12, further comprising:
a new intervention target presenting section controlling presentation of the user feature amount extracted by the new intervention target estimating section.

14. The information processing apparatus according to claim 2, wherein the description generating section uses, as inputs, the user feature amounts and the expected evaluated values provided by a plurality of the offline evaluation methods for the first intervention allocation and the second intervention allocation associated with each segment of the user feature amount, to generate the intervention allocation description using the offline evaluation model.

15. The information processing apparatus according to claim 1, wherein the description generating section generates the intervention allocation description including comparison information between the first intervention allocation and the second intervention allocation and comparison information between a first actual evaluated value for a result of the intervention performed on a basis of the first intervention allocation and a second actual evaluated value for a result of the intervention performed on a basis of the second intervention allocation.

16. The information processing apparatus according to claim 1, wherein the description generating section generates the intervention allocation description for each of the users.

17. The information processing apparatus according to claim 1, further comprising:
a presentation control section controlling presentation of the intervention allocation description.

18. The information processing apparatus according to claim 1, further comprising:
a model training section using a user log and the existing intervention, as an input, to train the learning model generating the second intervention allocation.

19. An information processing method comprising:
generating, by an information processing apparatus, an intervention allocation description including comparison information between a first intervention allocation indicating a correspondence relation between a user feature amount and an intervention and a second intervention allocation indicating a correspondence relation between the user feature amount and the intervention and newly provided using a learning model, and comparison information for an expected evaluated value between a case where the intervention is performed on a basis of the first intervention allocation and a case where the intervention is performed on a basis of the second intervention allocation.

20. A program causing a computer to function as:
a description generating section generating an intervention allocation description including comparison information between a first intervention allocation indicating a correspondence relation between a user feature amount and an intervention and a second intervention allocation indicating a correspondence relation between the user feature amount and the intervention and newly provided using a learning model, and comparison information for an expected evaluated value between a case where the intervention is performed on a basis of the first intervention allocation and a case where the intervention is performed on a basis of the second intervention allocation.
